(19) United States
(12) Patent Application Publication
(10) Pub. No.: US 2010/0299273 A1
(43) Pub. Date: Nov. 25, 2010

(54) Method and electronic integrated model generically facilitating efficiency with diffusion-based prognostics of operations, short-long term planning, risks, and impacts

(76) Inventor: Robert E. Downing, Pittsburgh, PA (US)

Correspondence Address: Robert E. Downing, P.O. Box 1131, Pittsburgh, PA, 15230, US

(21) Appl. No.: 12/454,528

(22) Filed: May 19, 2009

(51) Int. Cl. G06Q 10/00; G06Q 50/00

(52) U.S. Cl. 705/310; 705/348

(57) ABSTRACT

An improvement using electronic spreadsheet technology for operationalizing a single source (one Workbook) generic planning model of templates, as a unit suitable to microcircuitry and any storage medium, including risks and impacts for organizational, comprehensive, functional, financial, and systems planning (crisis prevention, technology impact, R/D) self-adjusting over one-five-fifteen year planning periods at a personalized or organizational level helping the user plan, manage, and make decisions more efficiently considering changing societal and technological conditions in compliance with 5(D)(1)-(2) Patentability on the drawing especially relevant to individuals, non-profit organizations, small businesses, government, and institutions in accord with documented authentication of origination in Declaration. The user can personalize a predefined master budget, generate non-financial or financial reports, organize resources, assess performance, and store forms.

### CROSS-REFERENCE TO RELATED PATENT APPLICATIONS

This patent application claims the benefit of U.S. Provisional Patent Application No. 61/123,428 filed May 21, 2008, for A METHOD AND ELECTRONIC INTEGRATED MODEL GENERICALLY FACILITATING EFFICIENCY WITH DIFFUSION-BASED PROGNOSTICS, the contents of which are incorporated herein by reference.

### COMPUTER PROGRAM LISTING APPENDIX

References in this paragraph are not for publication. The invention is an improvement to a computer program. This patent application therefore includes a computer listing under 37 CFR 1.96(c) on 2 compact discs prefaced with “Computer Program Listing Appendix” titled “CD Coding” in duplicate containing a Sec. 1.96(c) file titled “Computer Instructions by Drawing Views” of model referenced in description of drawing herein and having more than 300 lines of 72 characters per line. Each set is marked “Copy I” and “Copy 2”.

### BACKGROUND

Spreadsheet technology and templates were traditionally applied to business and government. Systems for finance and budgeting, management, and estimations became abundant. Planning programs were utilized for such applications as data collection, research, capital programming, real estate developments, modeling/simulation, impact analysis, etc. Special purpose templates emerged as needs were recognized. Forms of management information systems such as decision support systems (DSS), expert systems, or executive information systems (EIS) addressed problem-solving limited to businesses or managerial personnel. Personal organizers and utilities enabled scheduling, contact lists, basic calculations, multimedia display, and telecommunications. These systems, programs, templates, and utilities are from the perspective of applications.

However, it is noted that everyone has a need to plan. This includes visualizing current and future risks and impacts. Planning is a universal function and there are many types. Functionality therefore permeates through applications. Shortcomings of existing products or applications are: (1) applications are too specialized; (2) time to construct increases inefficiency; (3) expensive time-consuming IT conversion to current system; (4) data demands and maintenance are often extensive and costly; (5) projection processes or methods are often too complex for public use; (6) repetitive manual procedures; (7) expensive outlay to acquire; (8) storage requirements are often restrictive; and (9) use of the Internet increases security demands.

Architecture and engineering of existing spreadsheet technology were sufficient to remedy these. The Capability to integrate elements into a single unit was developed from the inventor's cumulative efforts during a 33 year period. The inventor recognized the feasibility when using his previously developed diffusion-based coding in a mult-year policy planning framework envisioned for a resource list and all activity plans of a non-profit organization with abstractions.

Coding is the process of providing rules and algorithms as instructions to a computer. Forecasting models' and projection models' sophistication (systems analysis, operations research, etc.) and data requirements prohibit small-scale use. Technology assessments are vast and demanding. Crisis management systems normally estimate resources and response times without impacts. All require extreme detail and large-scale operation. Basic functions relevant to individuals of personal budgeting, organizing resources, generating non-financial or financial reports, and filing forms are proliferated in separate software. For example, Micosoft's Office Project Standard and Office templates exemplify the need to simplify and consolidate form and function of project management and individual budgets-forecasts-planner (special events) templates with estimations beyond five years. These specializations and separate programs are inefficient.

Daily activity-basic functions-projects/programs/plans-goal attainment-risks/impacts as interrelated to projections beyond 5 years based on changing conditions provide a practical management information system. When embodied as an integrated unit, it improves efficiency. Multisystem change (social, political, environmental, etc.) better assesses effects than multifunction statistical projection (housing, transportation, weather, etc.) as more inclusive.

Microcircuitry has enabled personal digital assistants (PDAs or pocket computers) which provide many features of PCs or notebooks. They are limited by storage capacity, display area, and time of use without external equipment. In addition, the Internet is a computer-computer communication requiring a server and additional security for access. Spreadsheet technology which uses macros also requires additional security. Human activity includes human-human interaction often accomplished by cell phones where planned more efficient use of time would improve physical contact of individuals, families, and groups.

Integrating such functionality to allow individual, small-scale, and large-scale use remedying the shortcomings would improve efficiency, privacy, personalization, affordability, and mobility. Prior to this invention, this did not exist.

A personal management information system was needed.

### BRIEF SUMMARY

This invention includes 2 interdependent components: process and model. It consists of (1) a drawing presented as a shaded and gradient flow diagram depicted on 41 pages or an approximately 14,448 cell electronic spreadsheet and (2) a functional model represented on the drawing as 2-4Bb (cells A34-Z525, FIGS. 3-34) and operable as a secured CD-ROM subject to regulations related to nonprovisional examination and with pending or issued trademark clarifying use and novelty of a functional utility patent. Authentications and originality related to process of making invention are referenced in this Description.

### BRIEF DESCRIPTION OF VIEWS OF THE DRAWING

The descriptions in paragraphs 11, 19-21 and 24 are clarified by the following views of the drawing of the drawing denoted by the figures and cell references.

FIGS. 1-4 are a diagram on cell references A1-AD65 depicting the first of five parts titled “Recognize Needs” which is cell references B11-V40.

FIGS. 3-12 are a diagram on cell references A33-AD197 depicting the second of five parts titled “Outline General Structure” which is cell references B34-S183.

FIGS. 11-32 are a diagram on cell references A165-AD518 depicting the third of five parts titled “Construct and Code” which is cell references B183-Y502.

FIGS. 31-34 are a diagram on cell references A486-AD551 depicting the fourth of five parts titled “Security” which is cell references B503-P527.

FIGS. 33-41 are a diagram on cell references A519-0680 depicting the fifth of five parts titled “Proprietary Rights and Distribution” which is cell references B528-V665 with FIG. 36 showing the last cell used in column V.

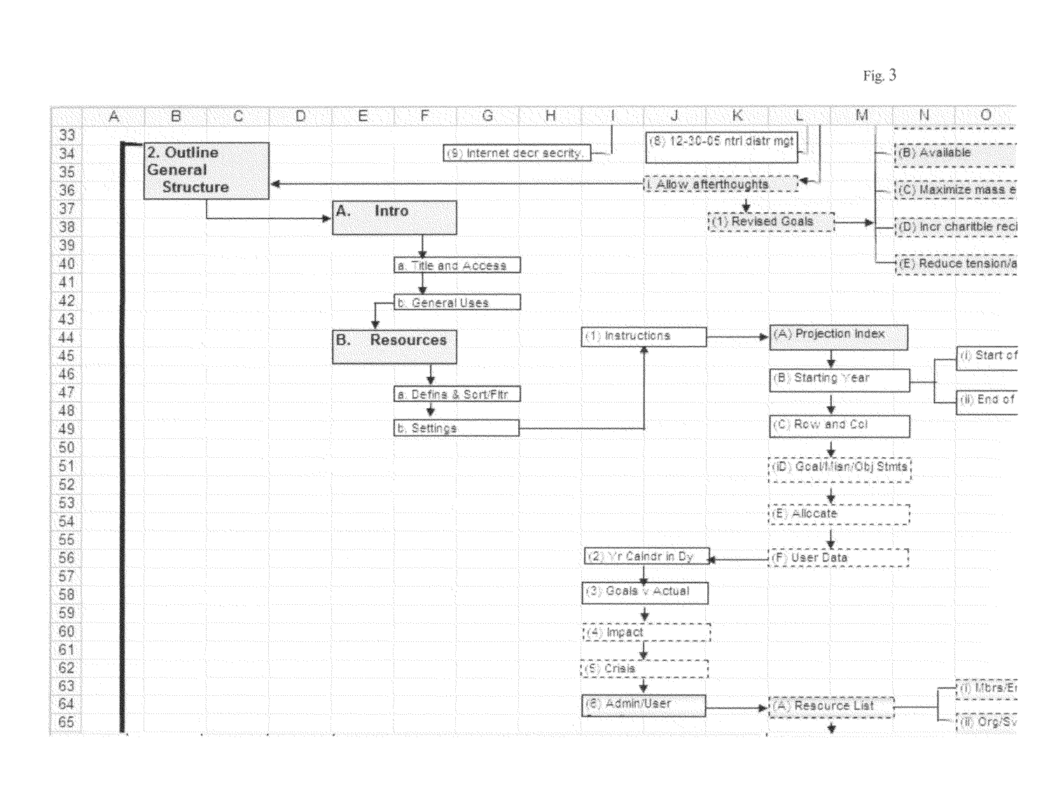

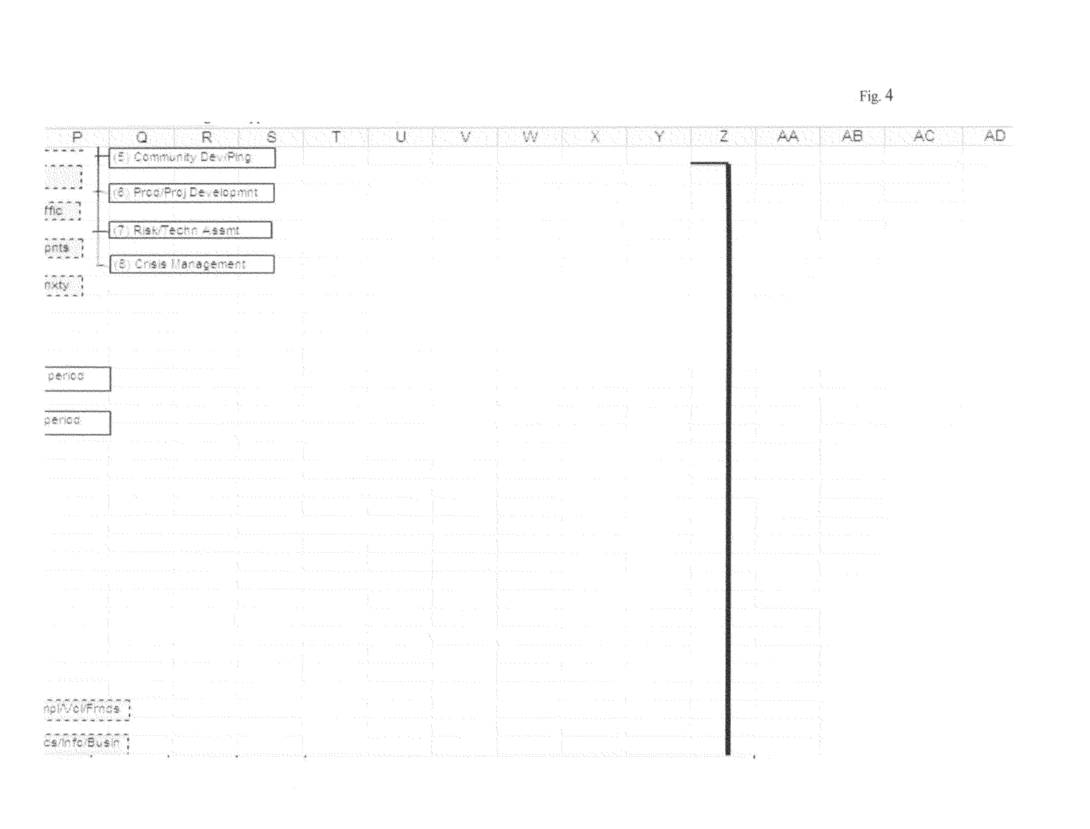

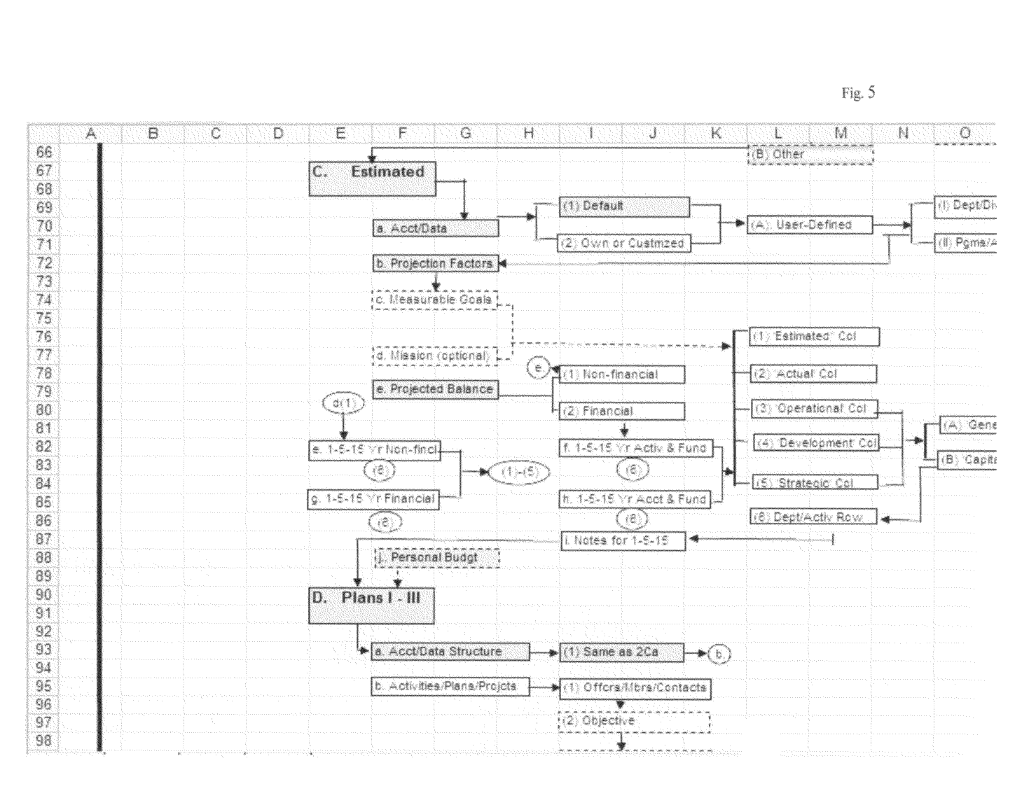

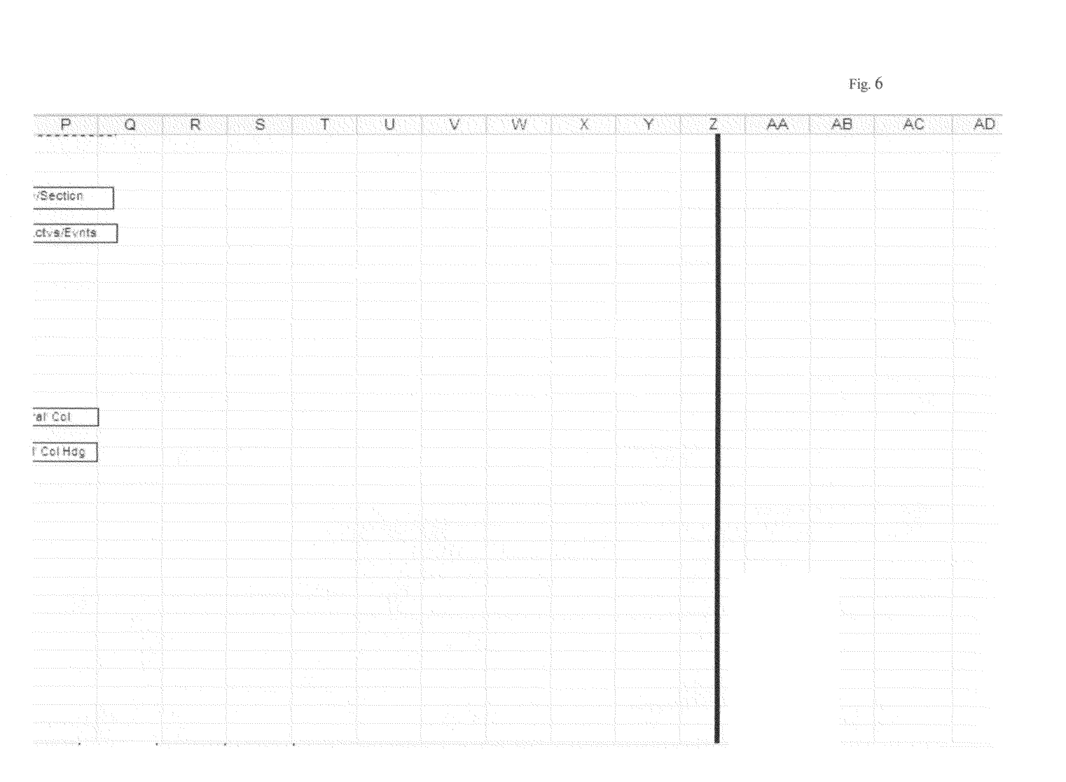

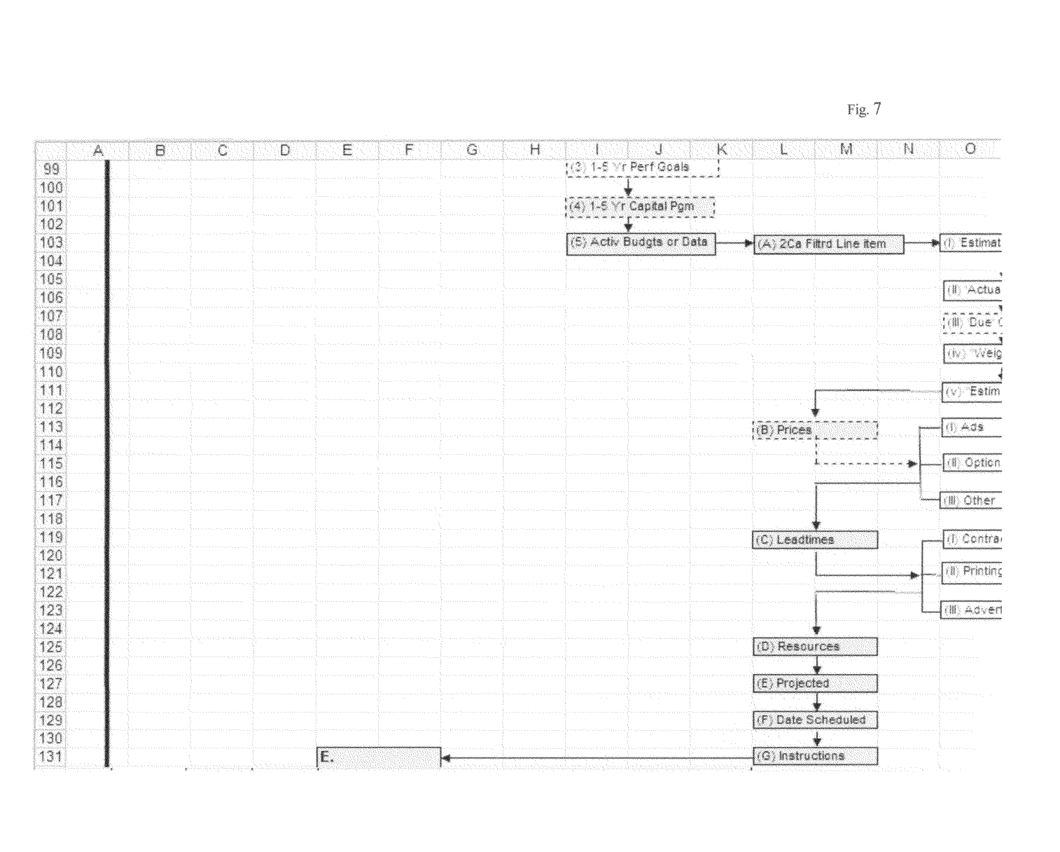

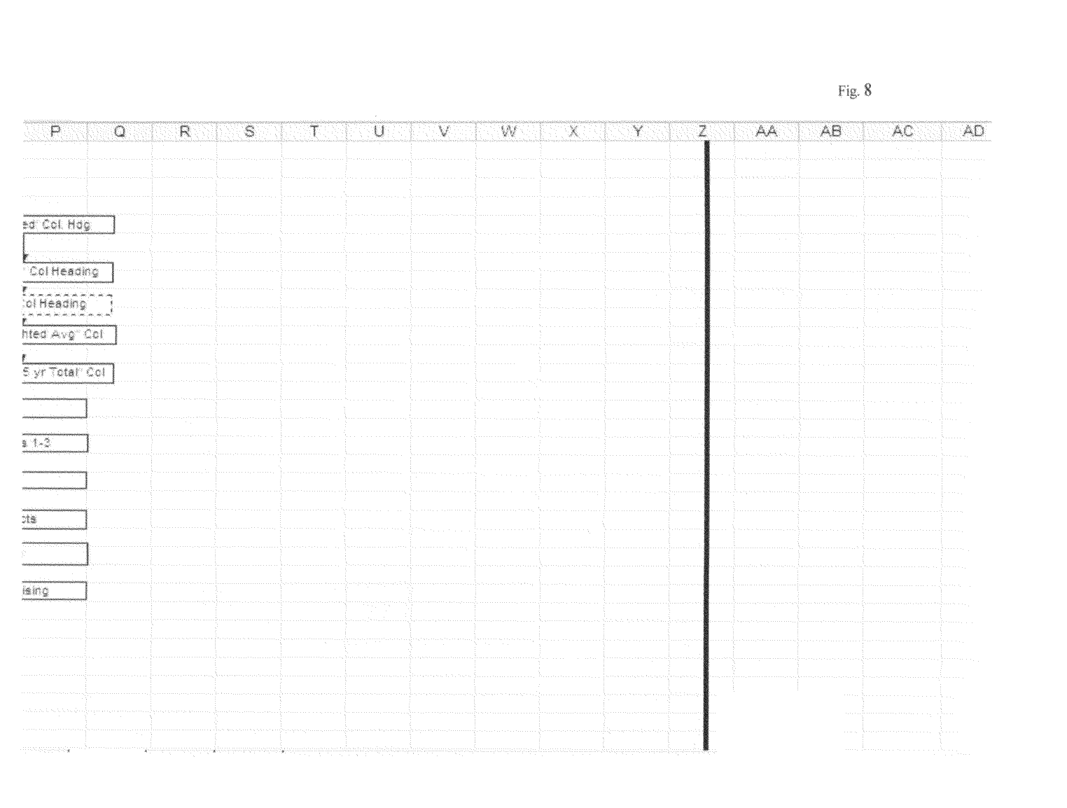

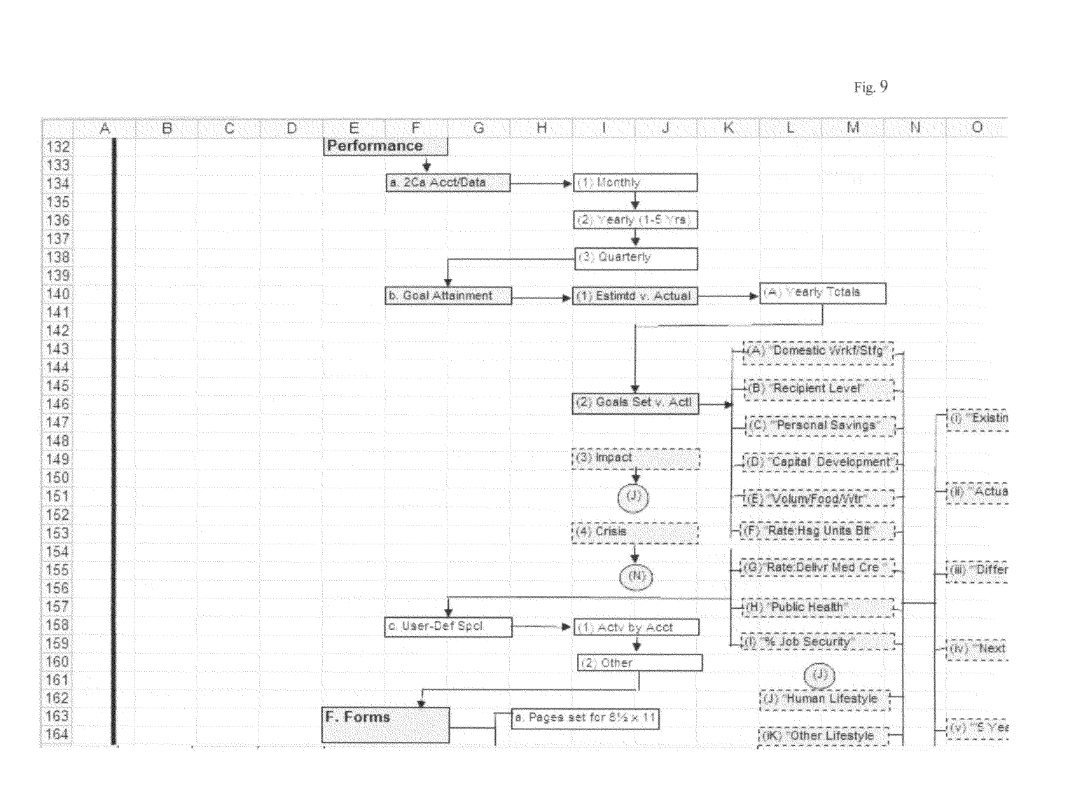

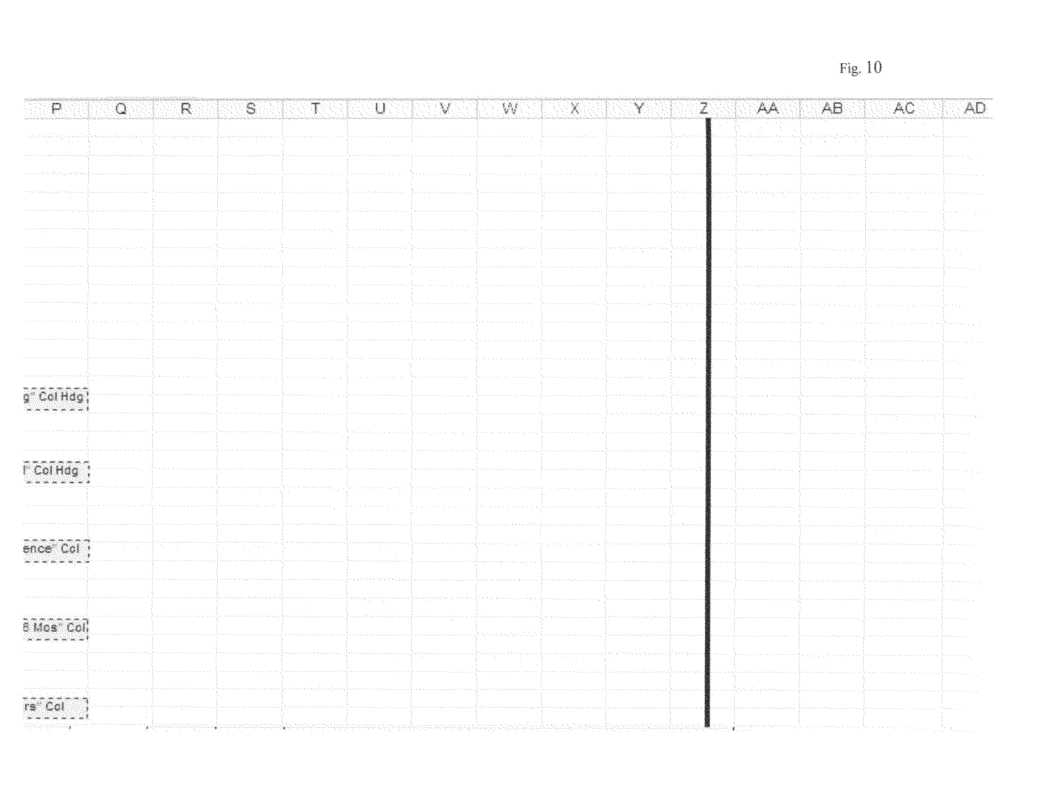

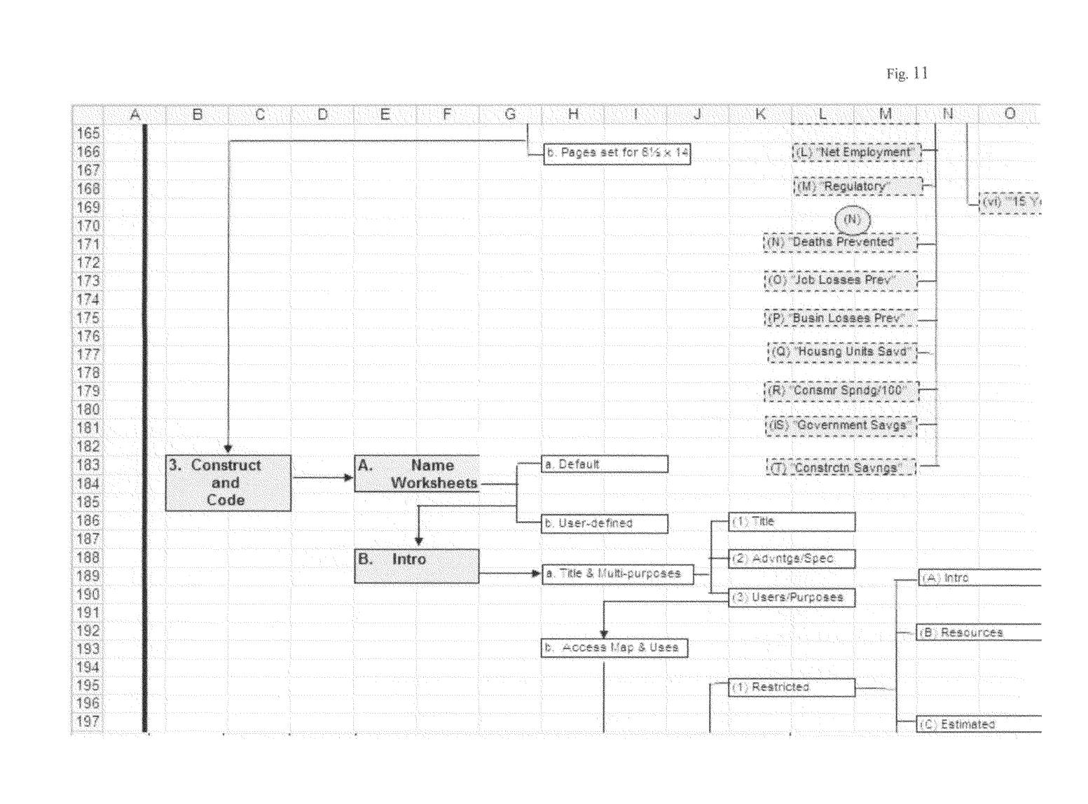

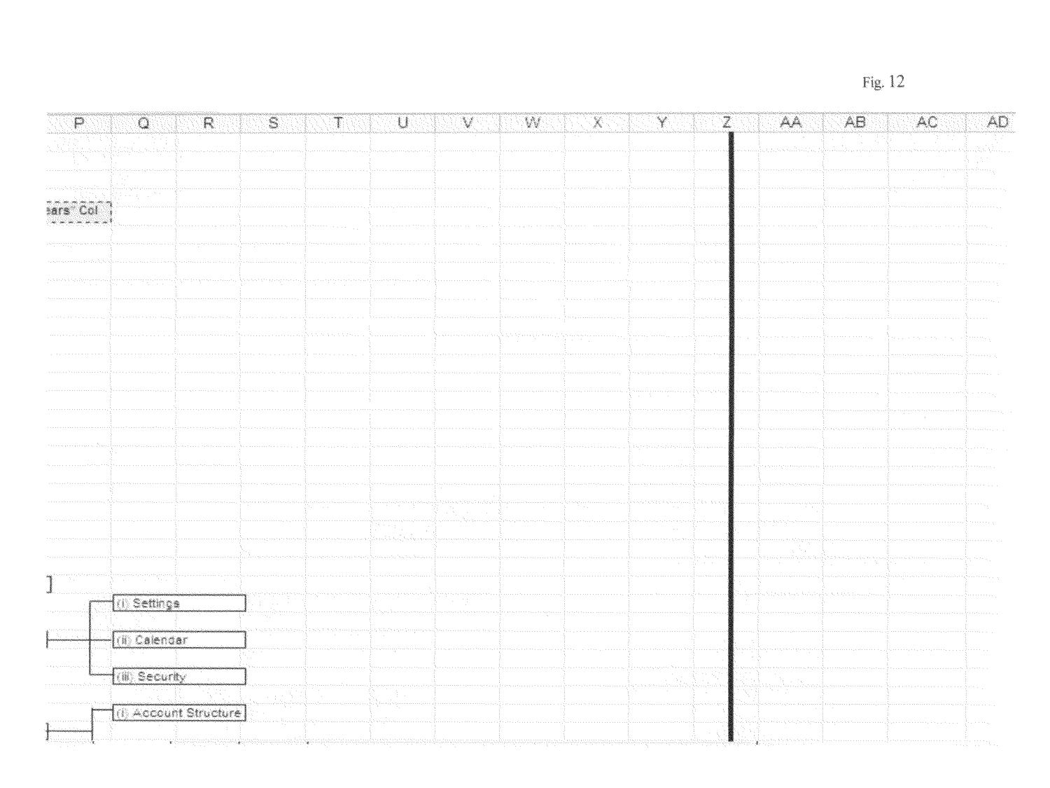

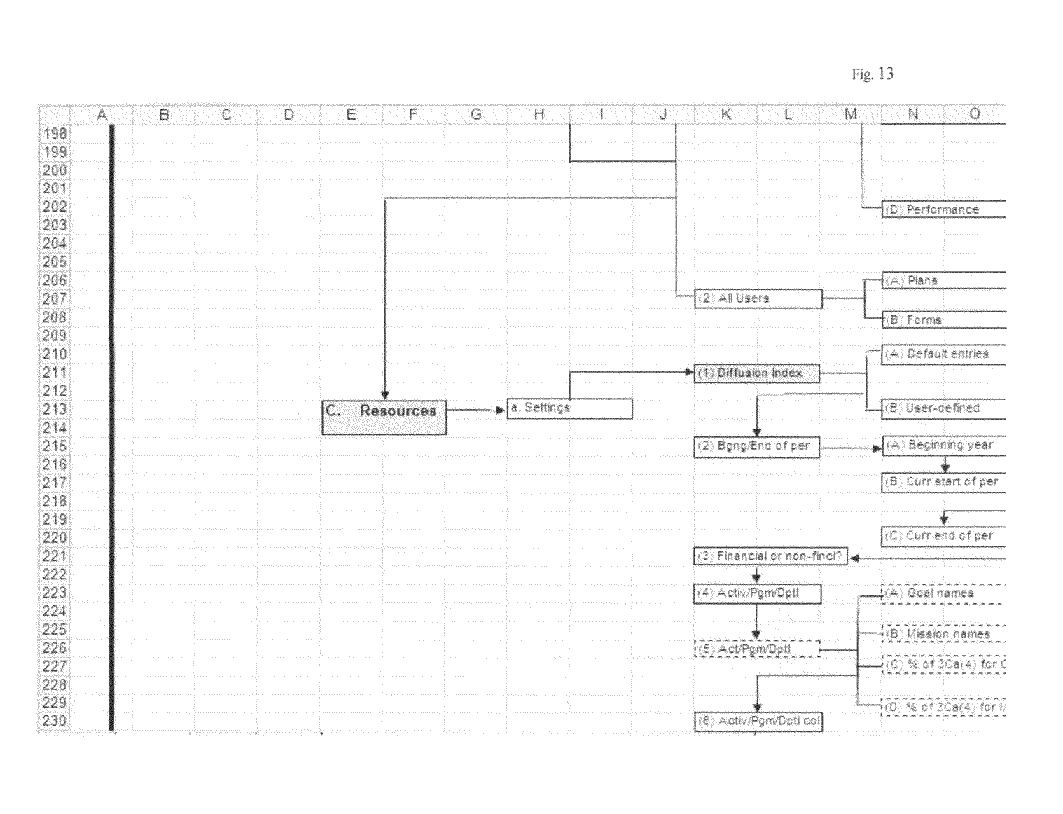

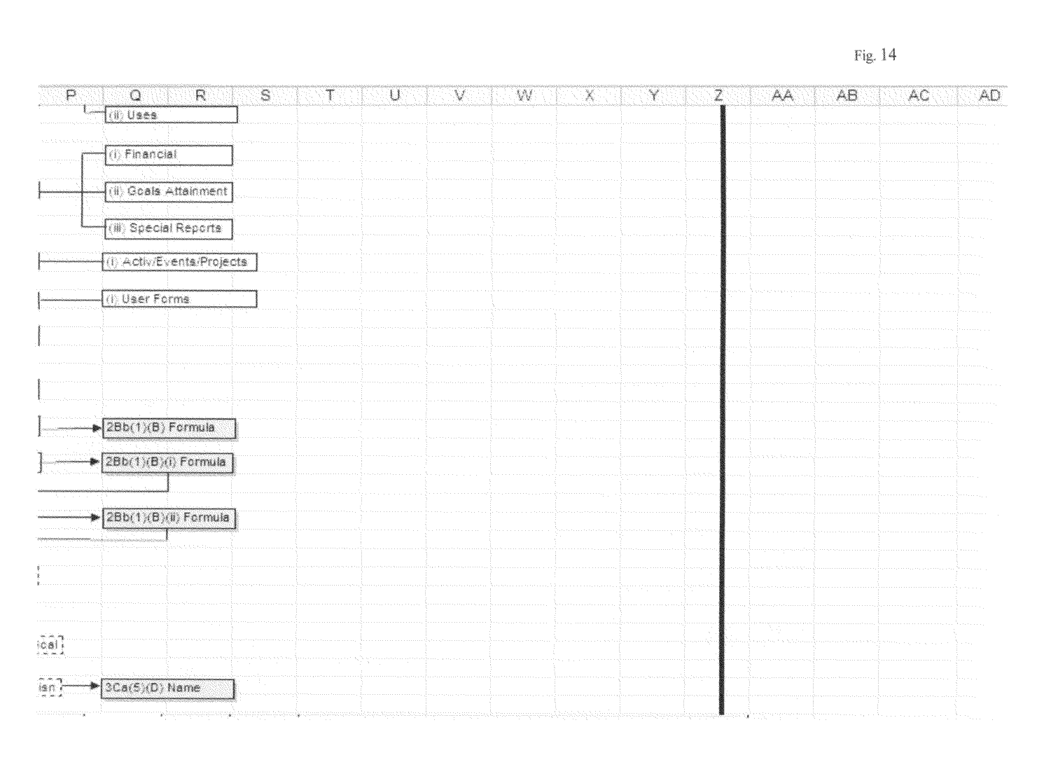

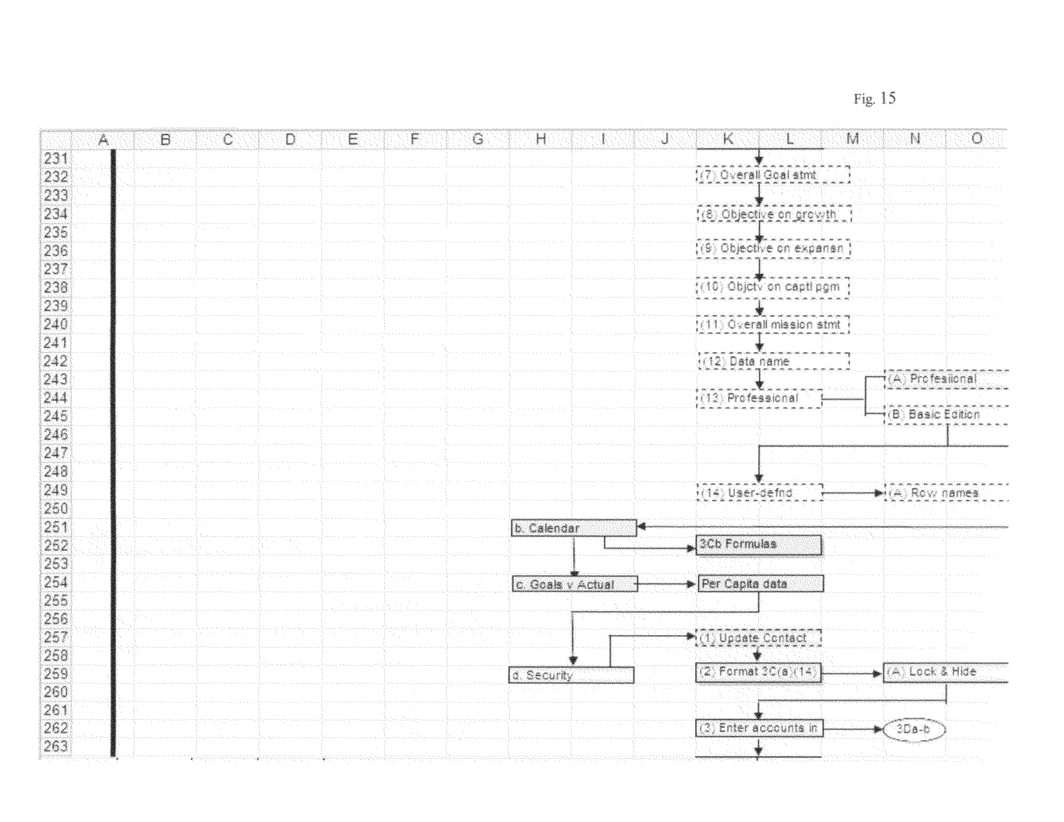

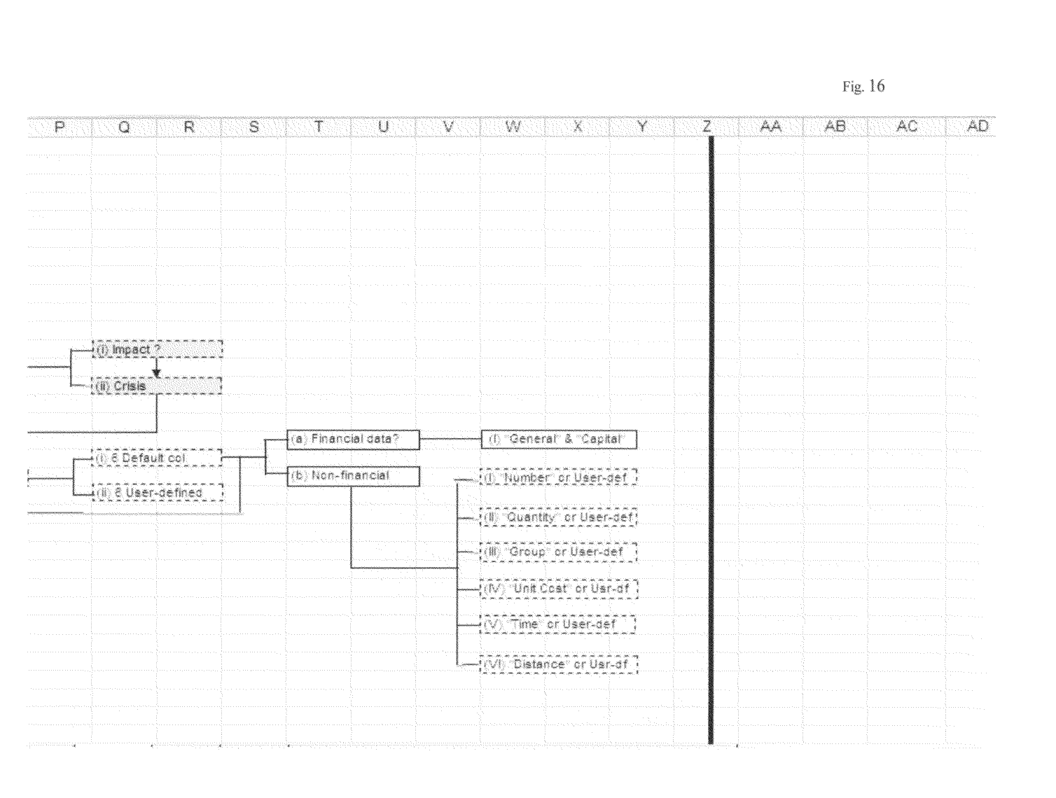

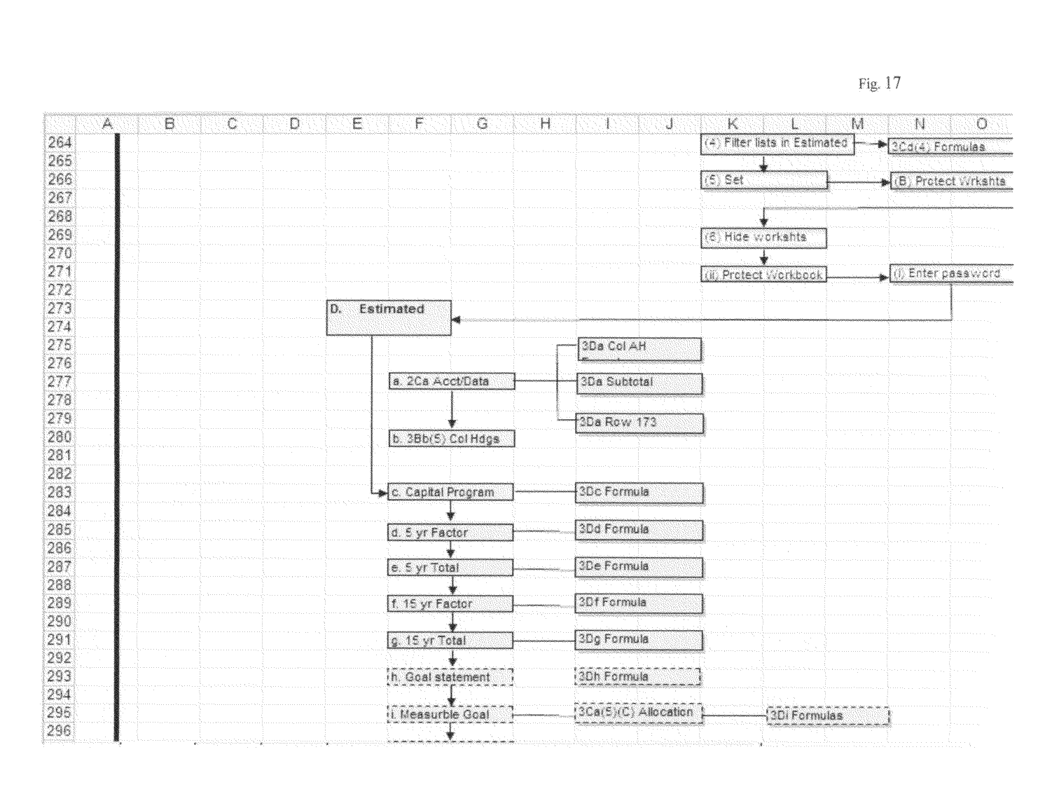

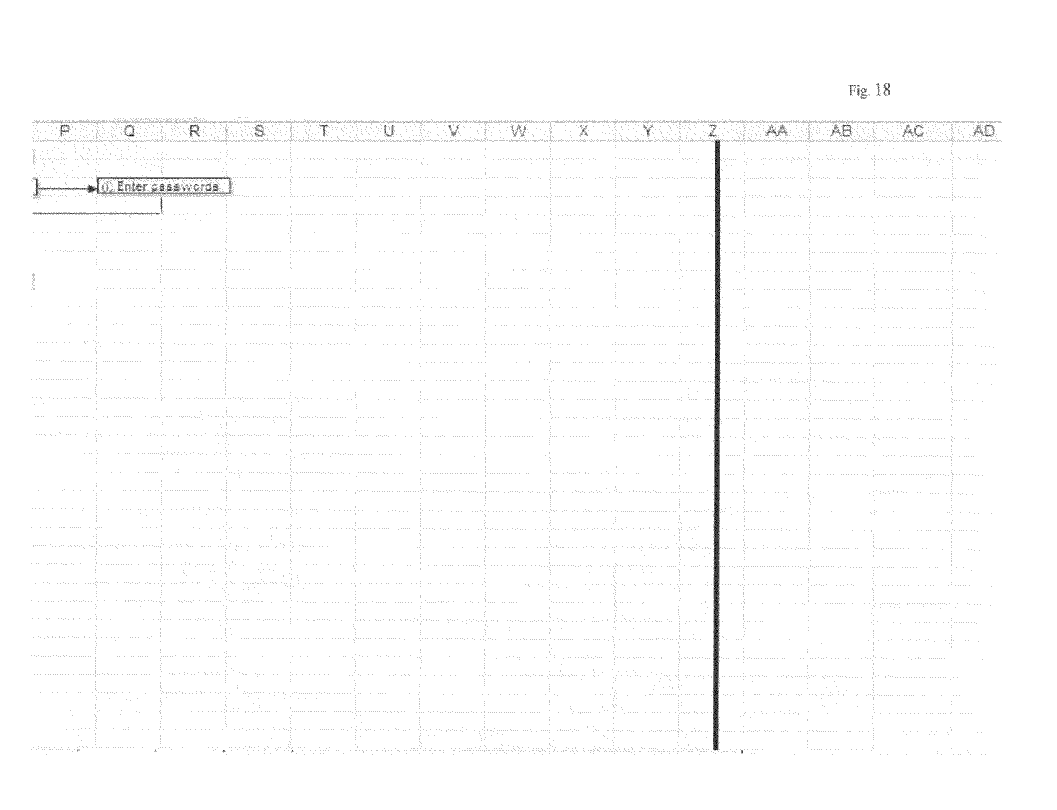

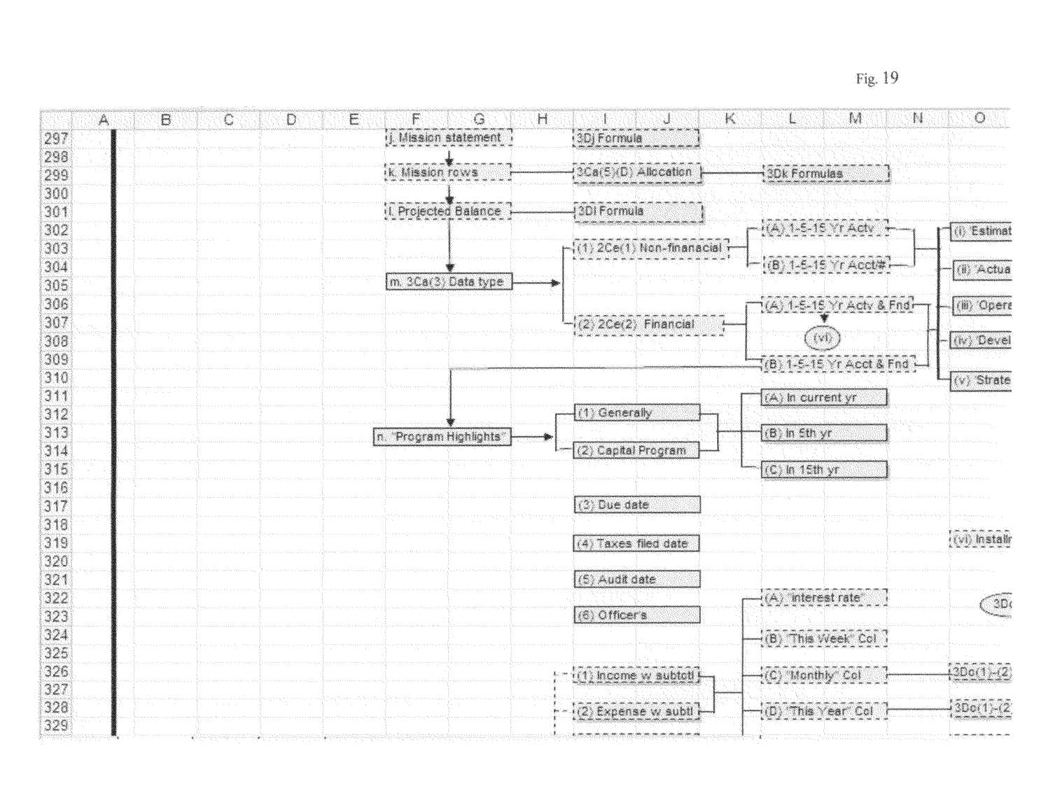

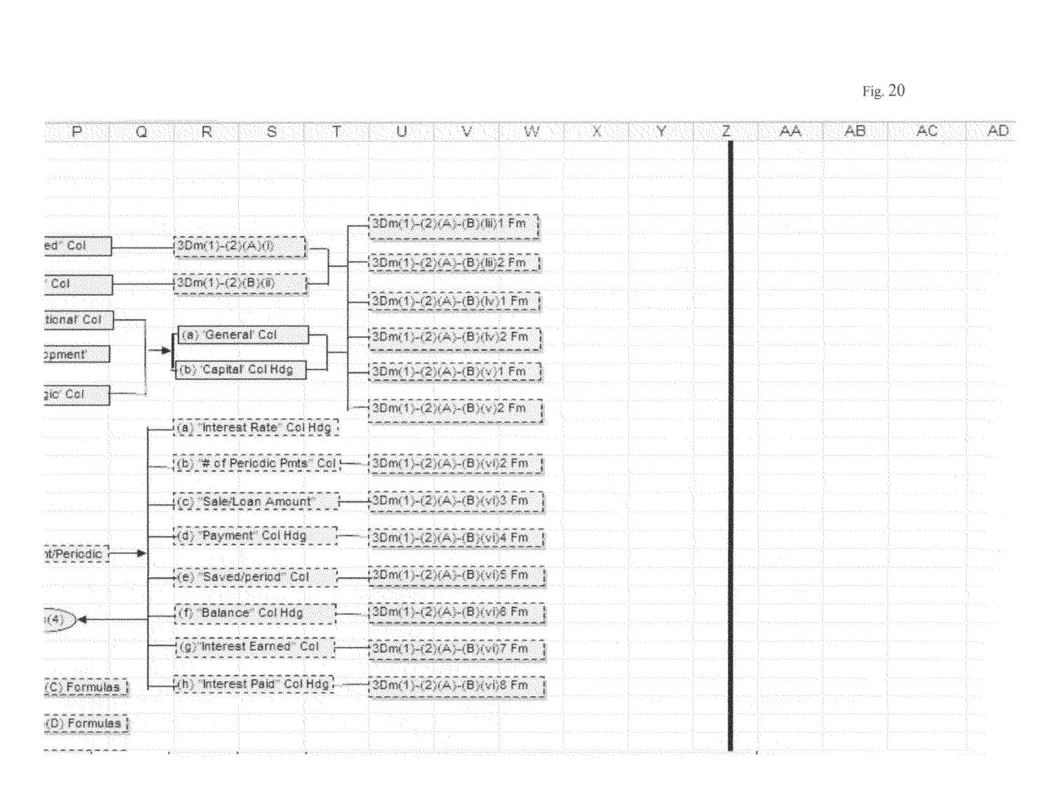

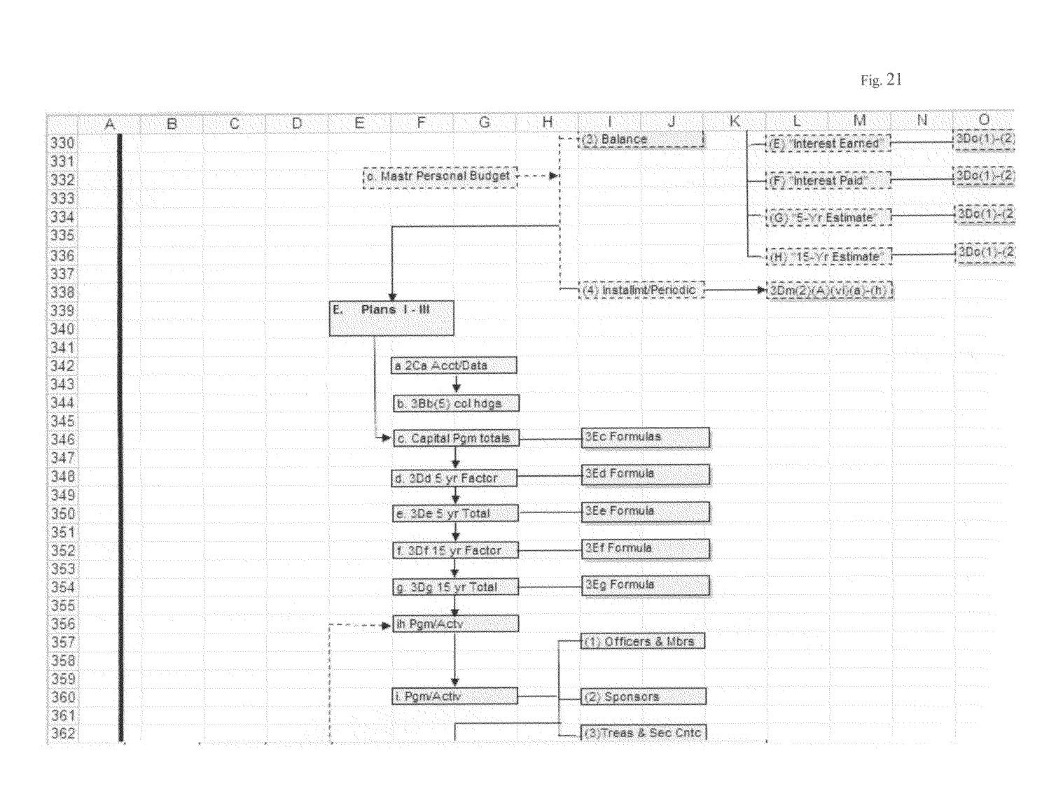

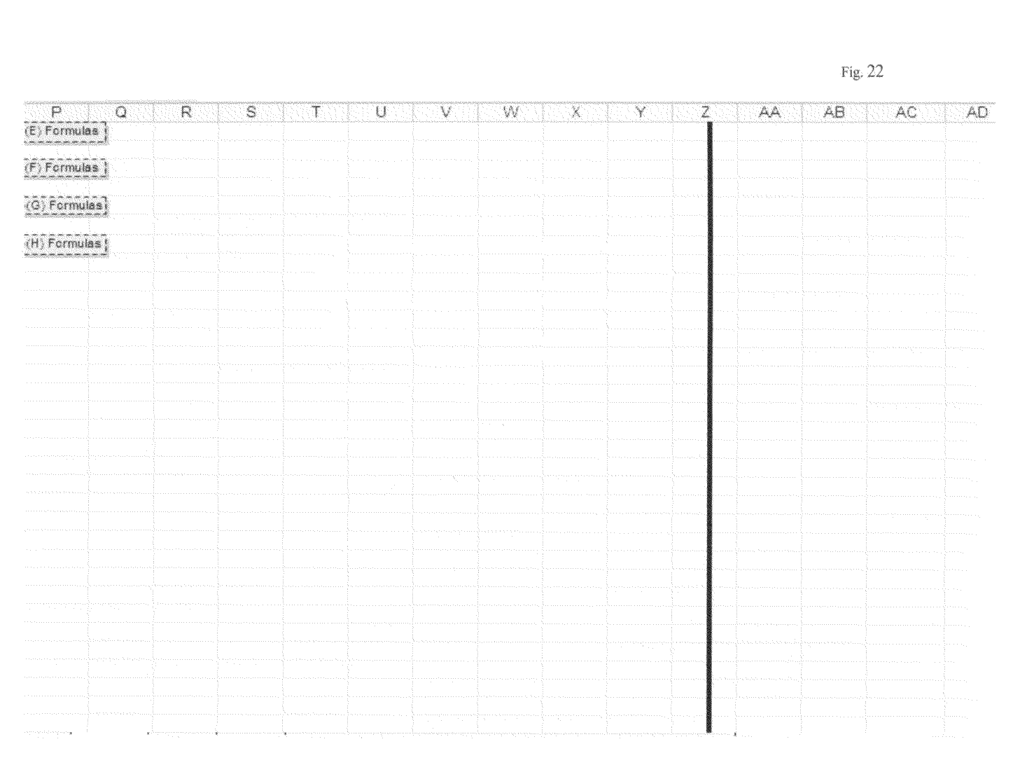

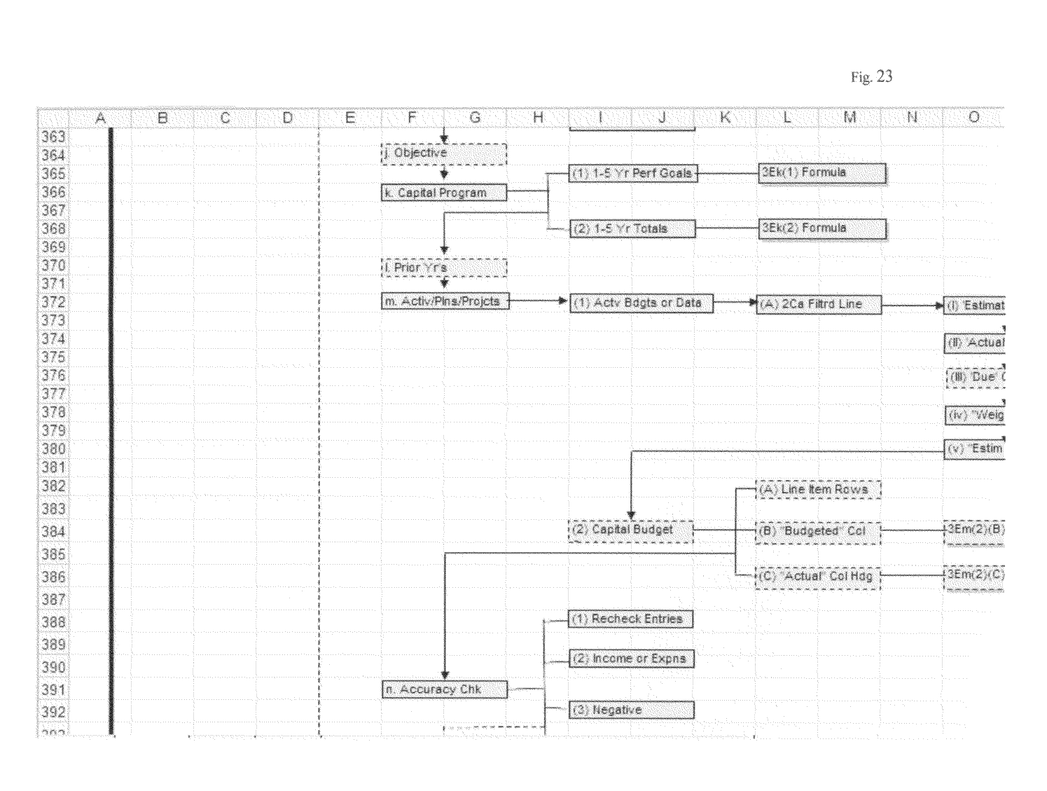

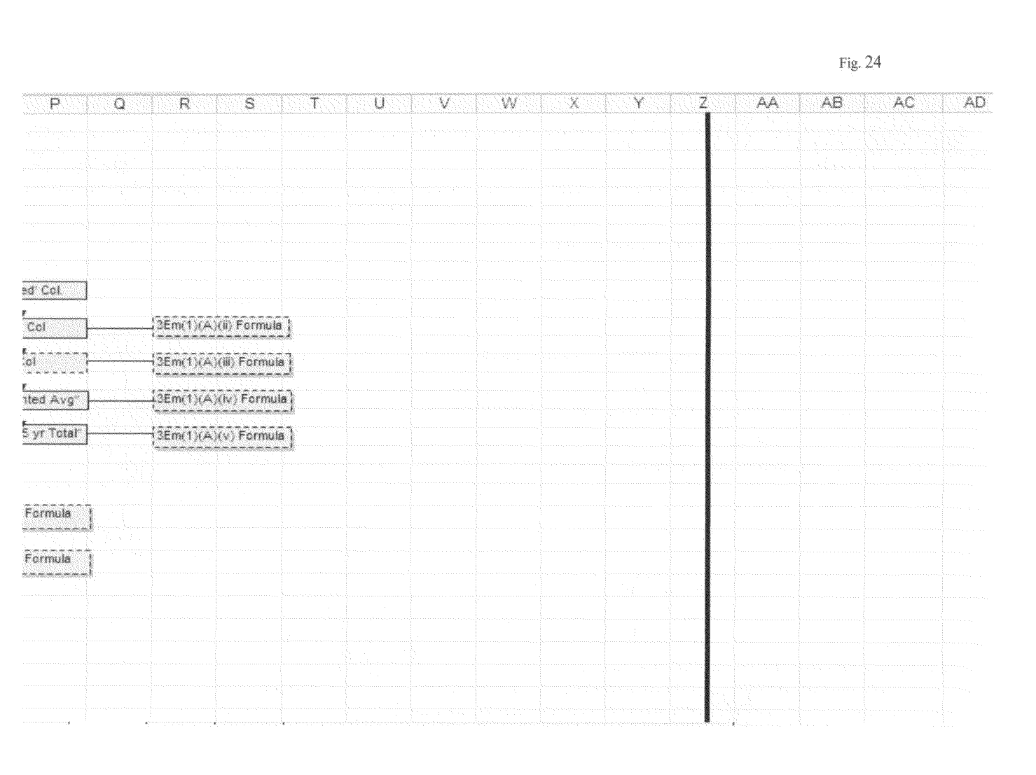

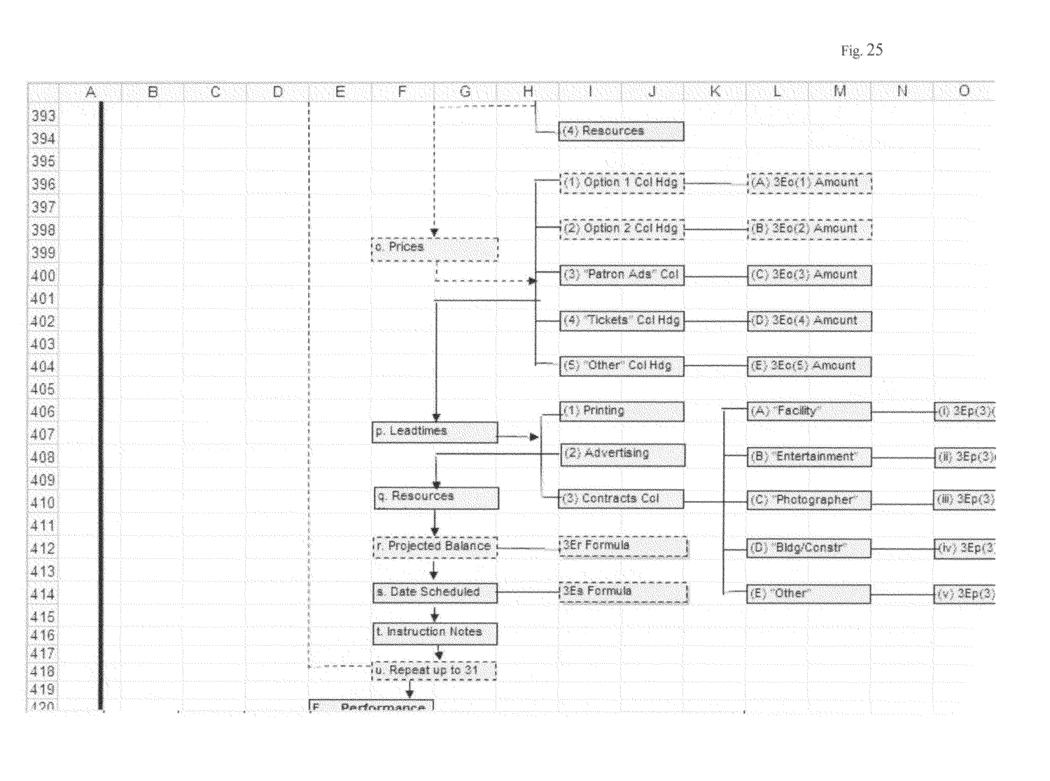

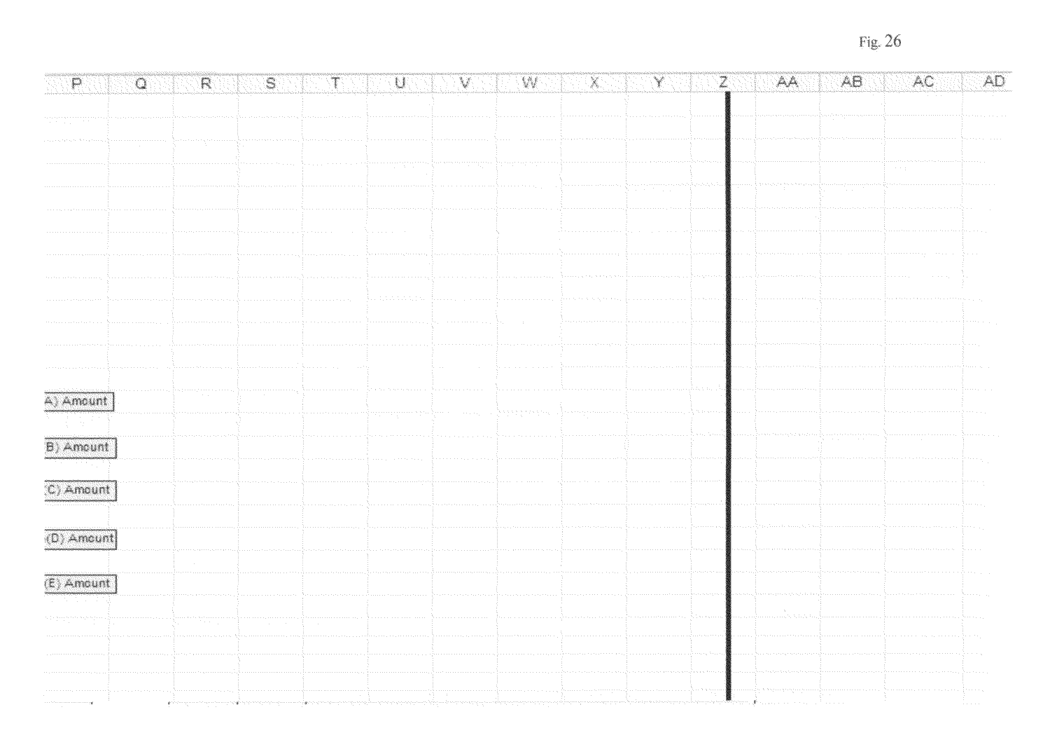

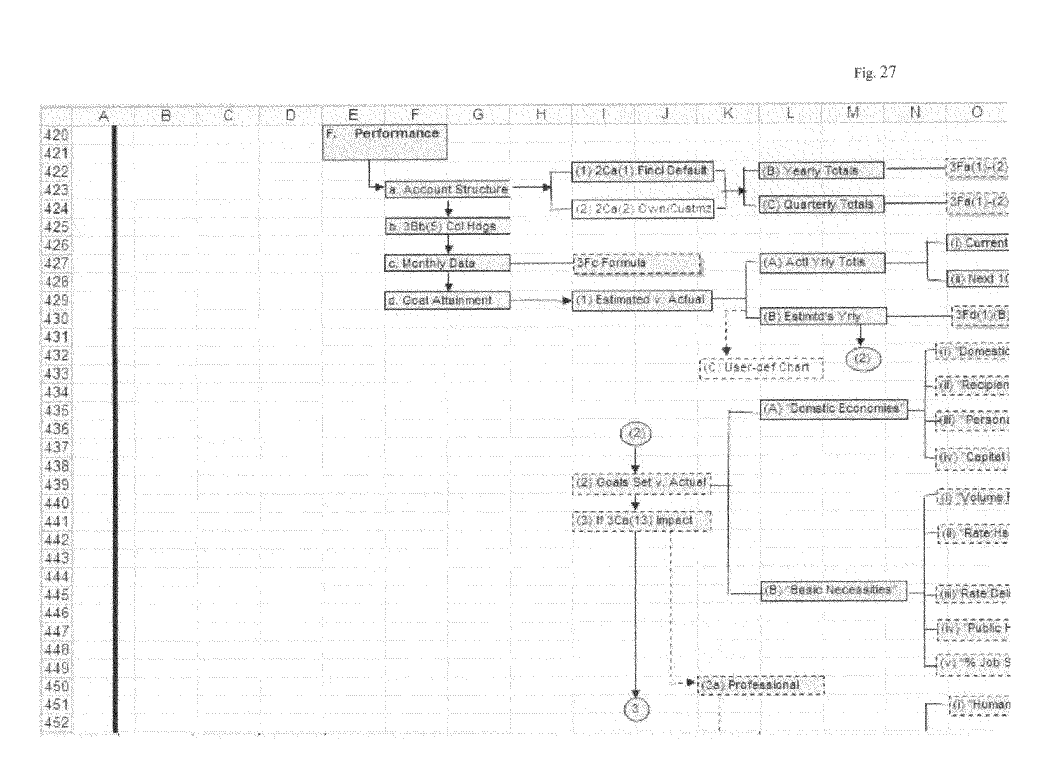

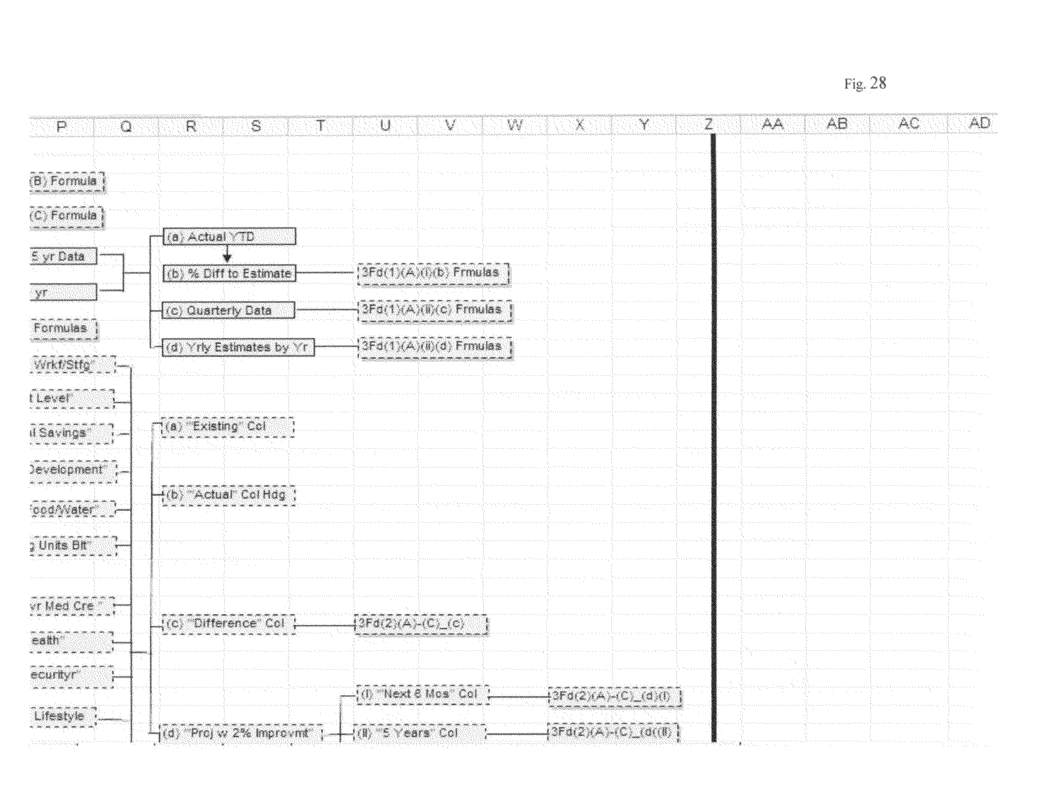

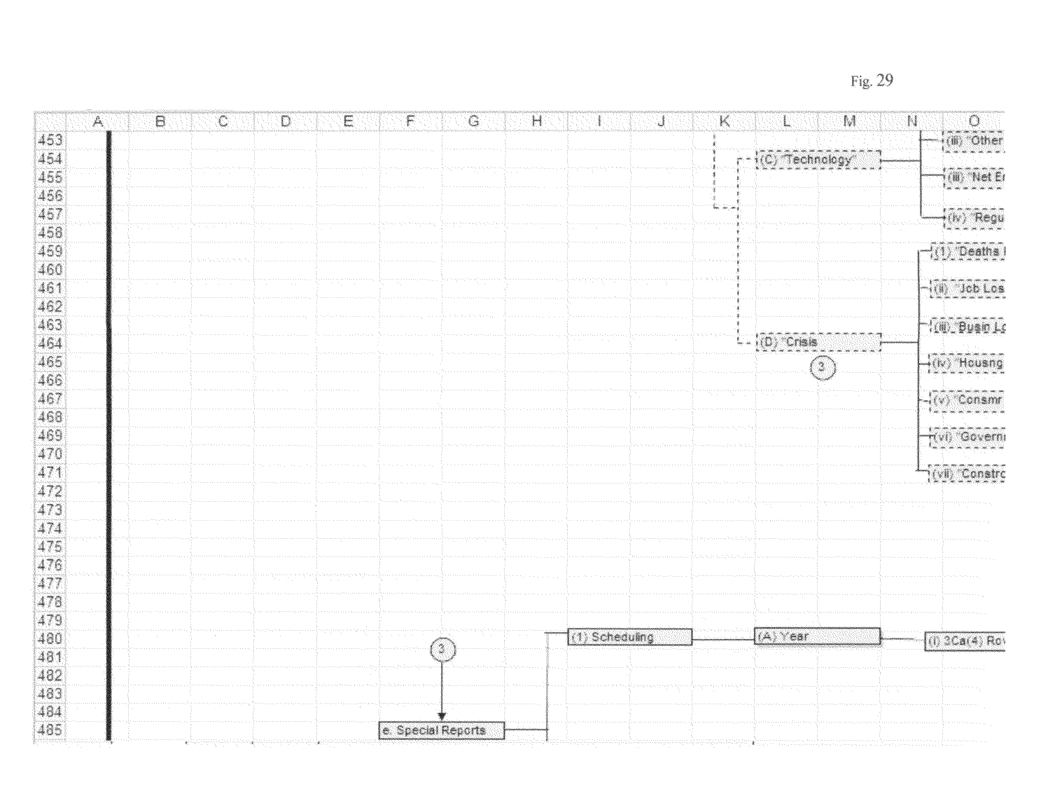

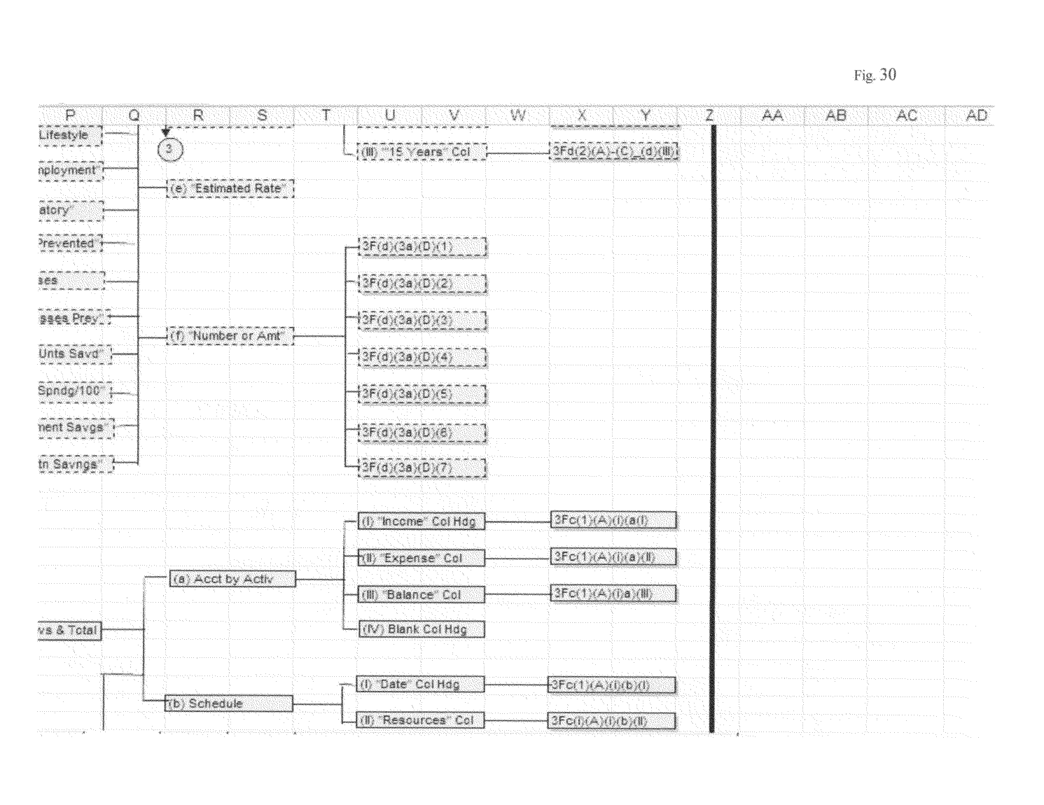

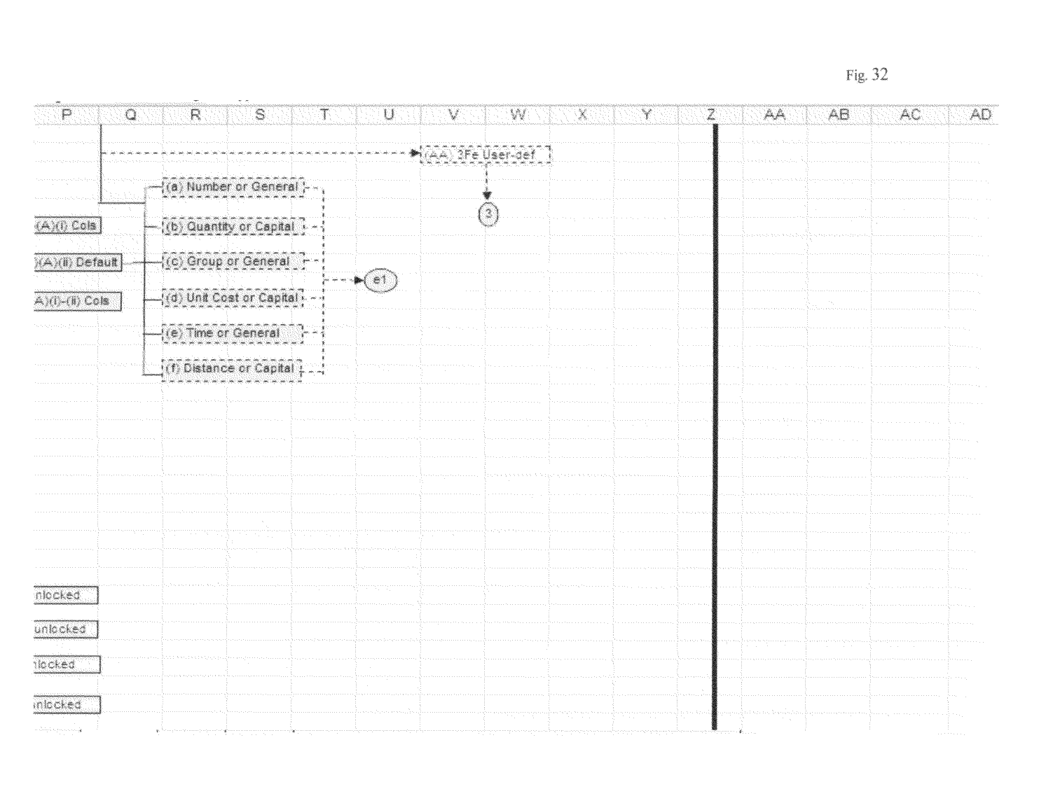

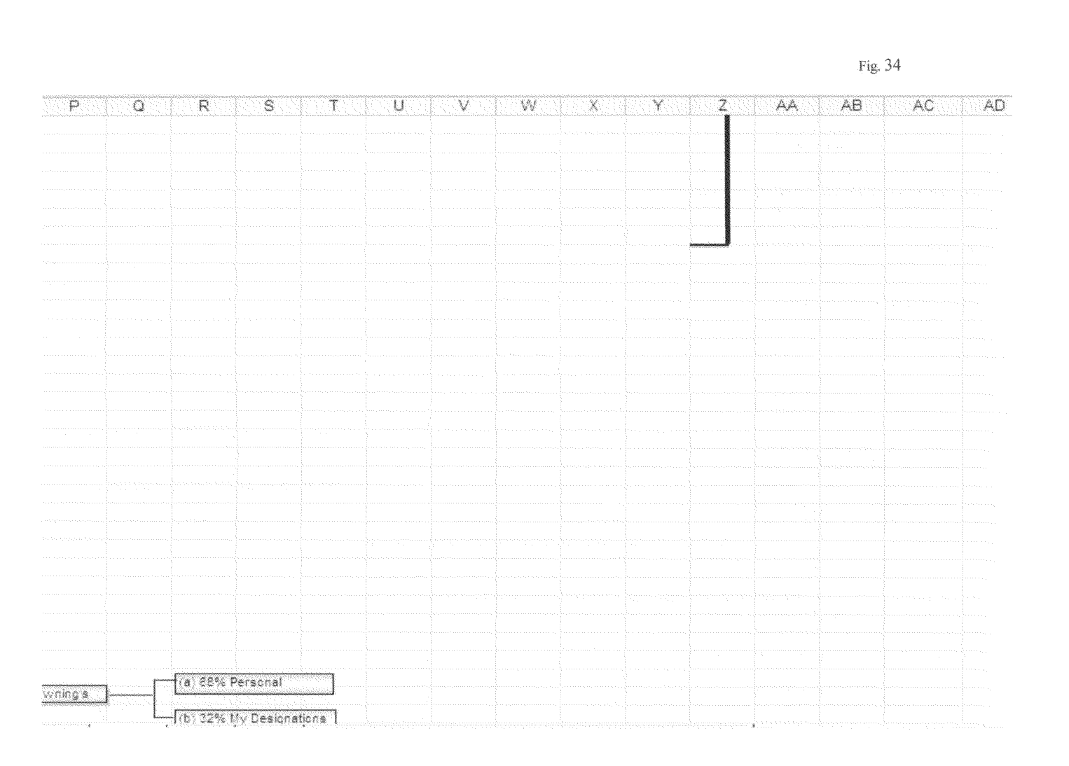

FIGS. 3-34 are a diagram on cell references A33-AD551 depicting the model which is cell references A34-Z525.

### DETAILED DESCRIPTION

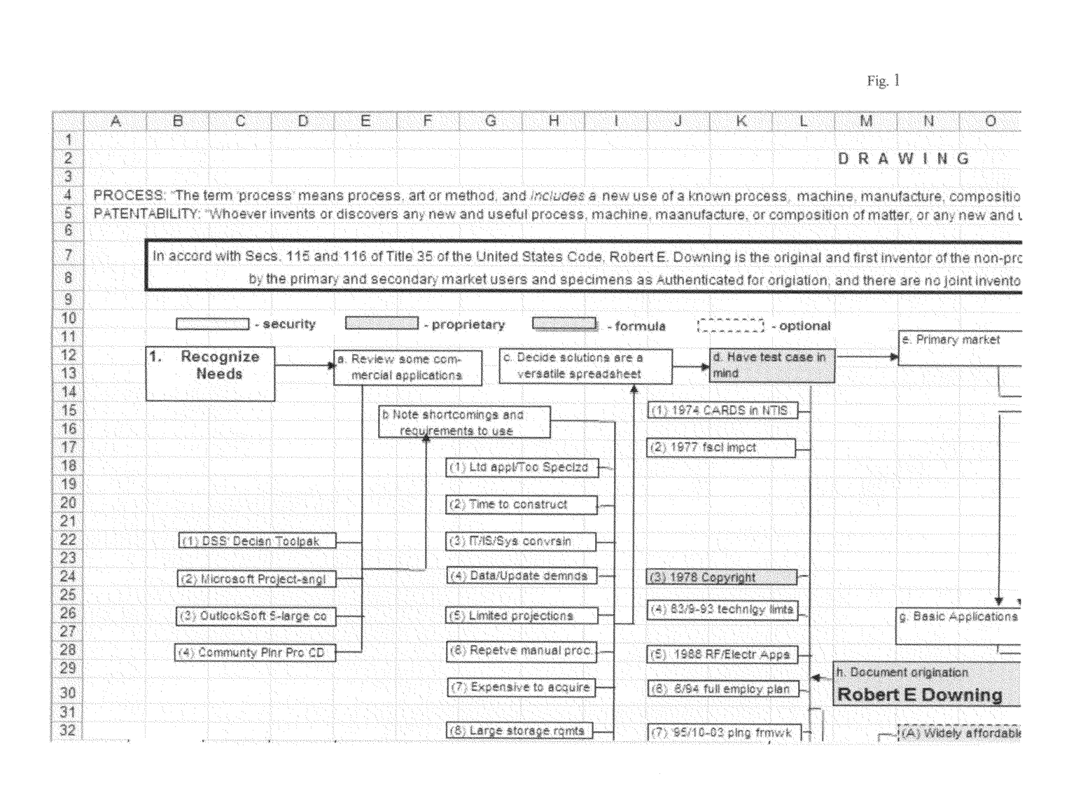

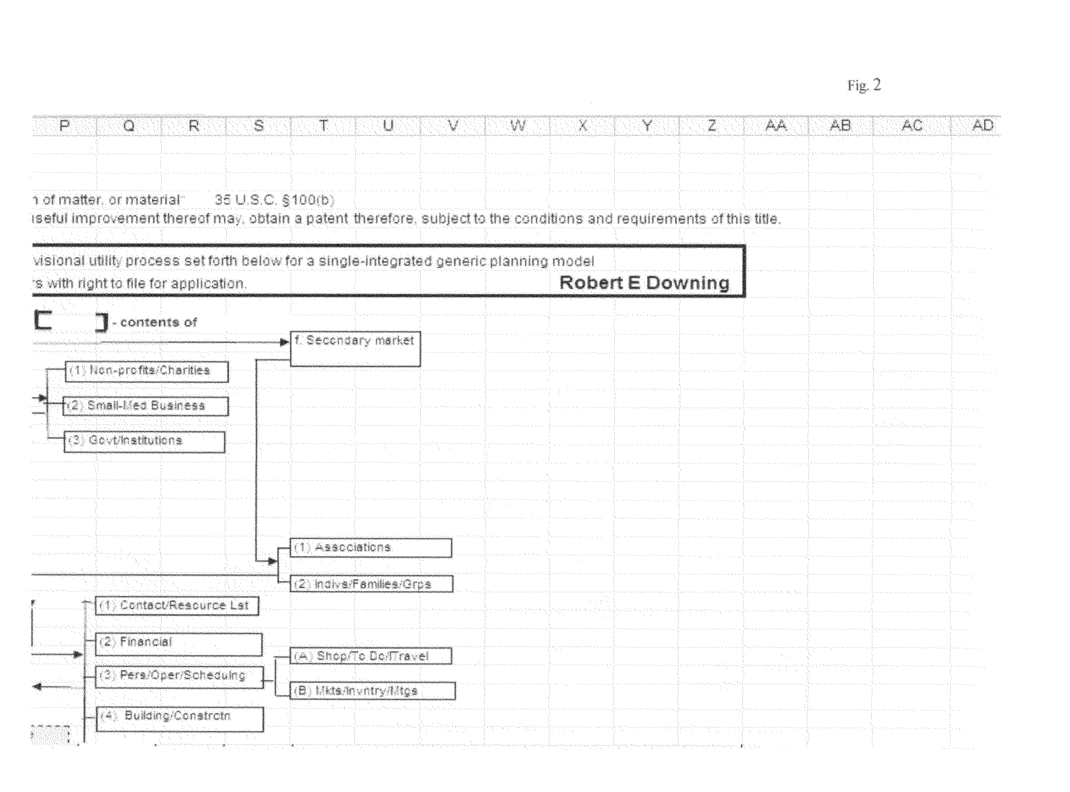

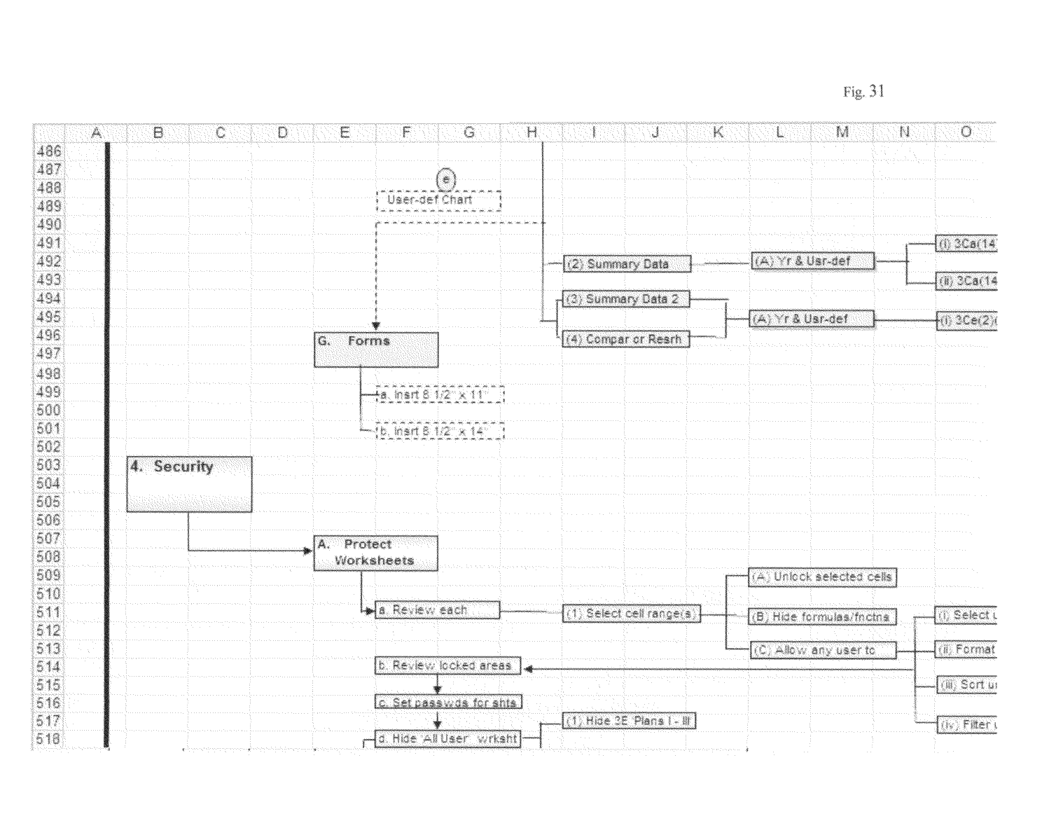

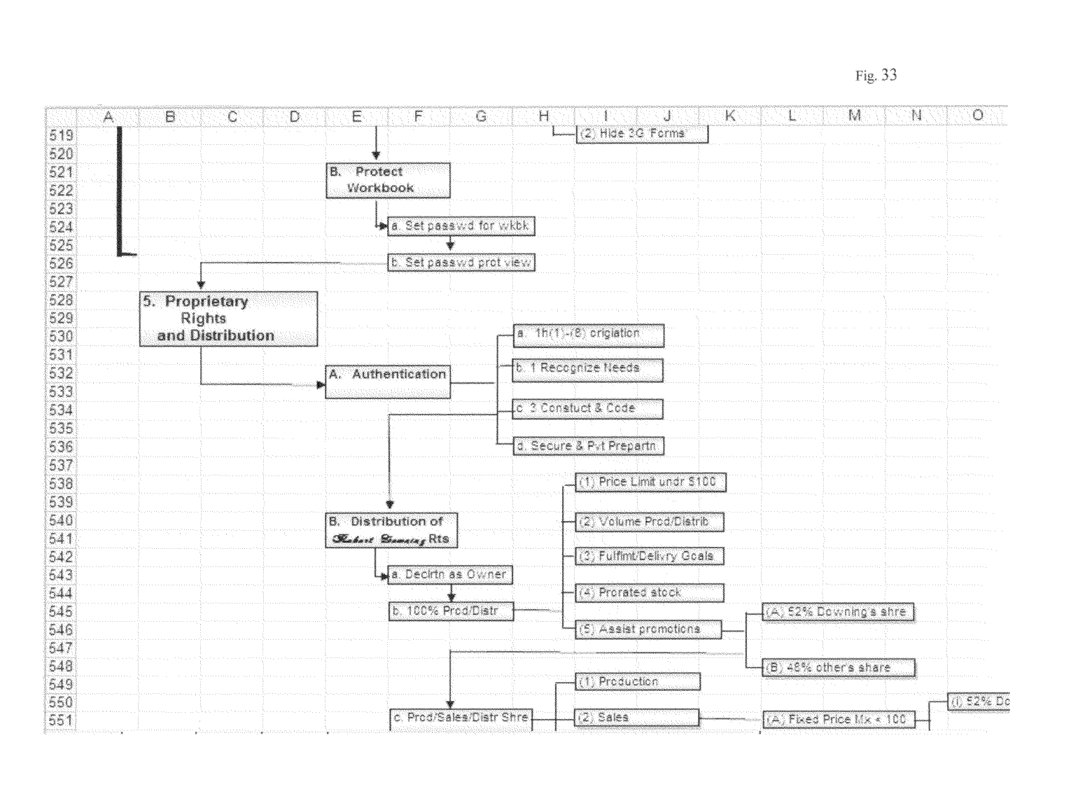

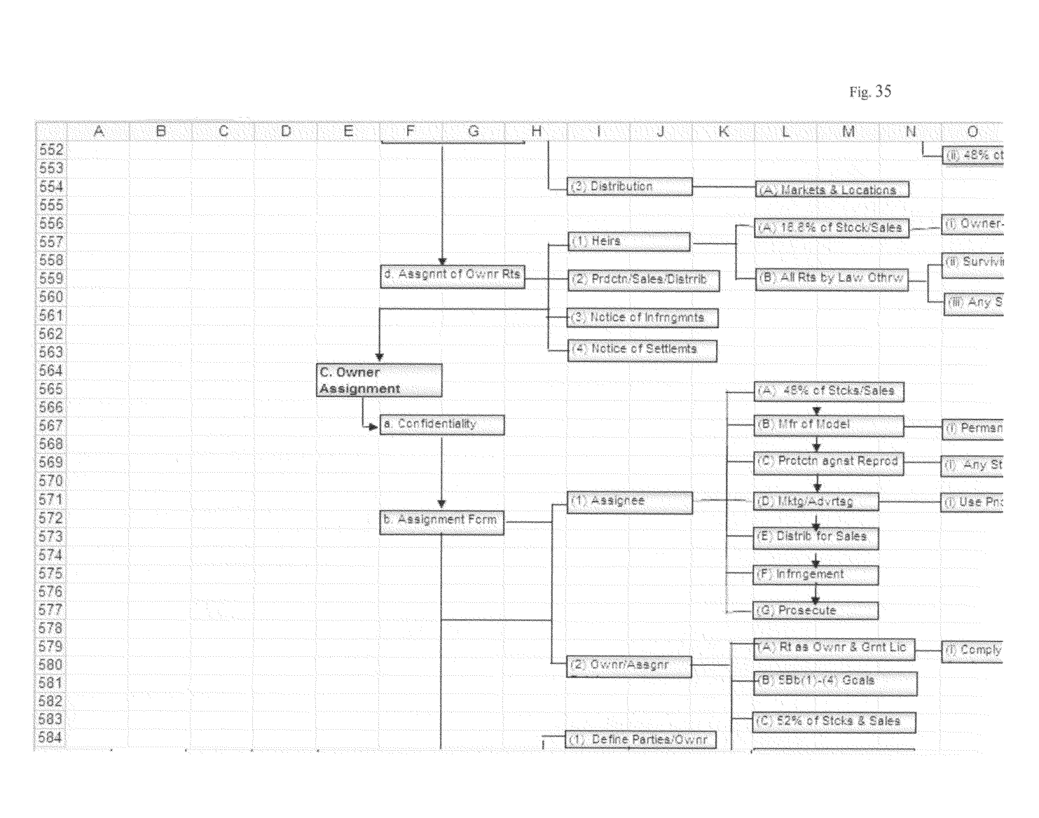

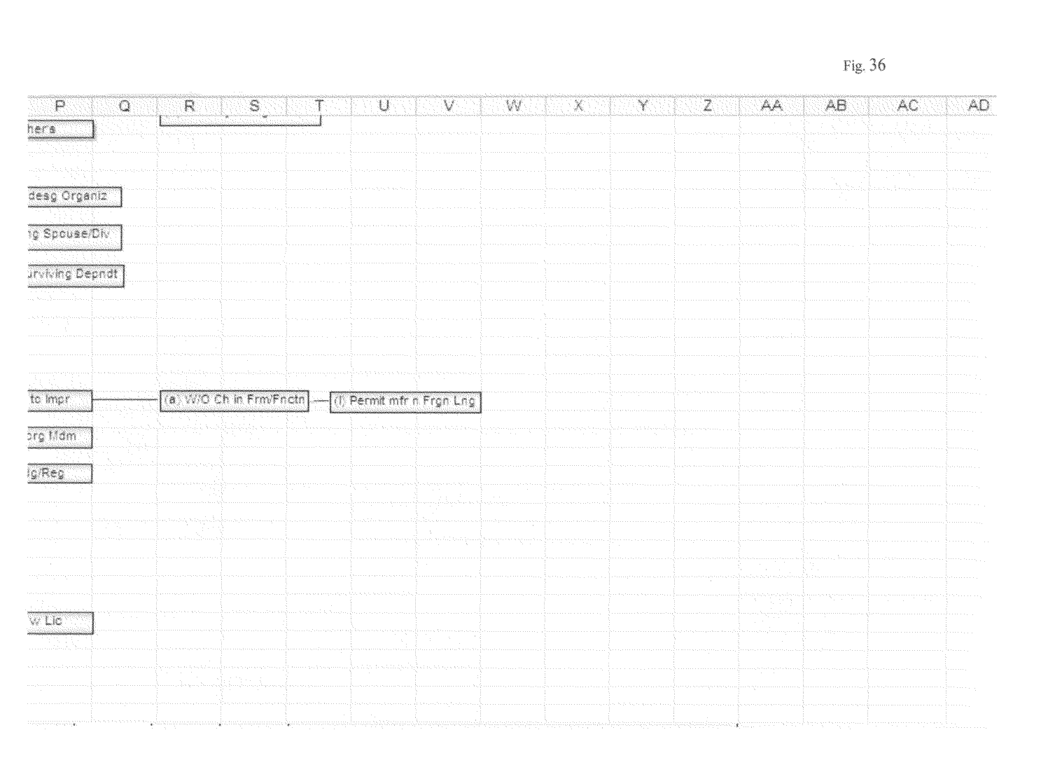

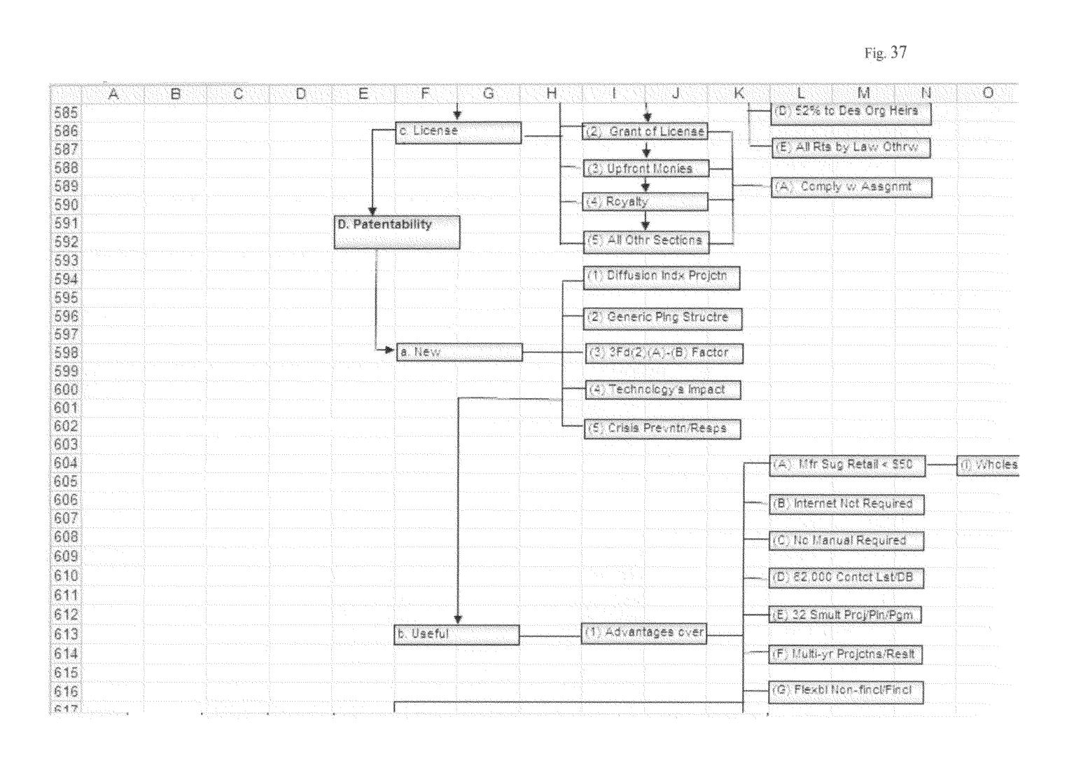

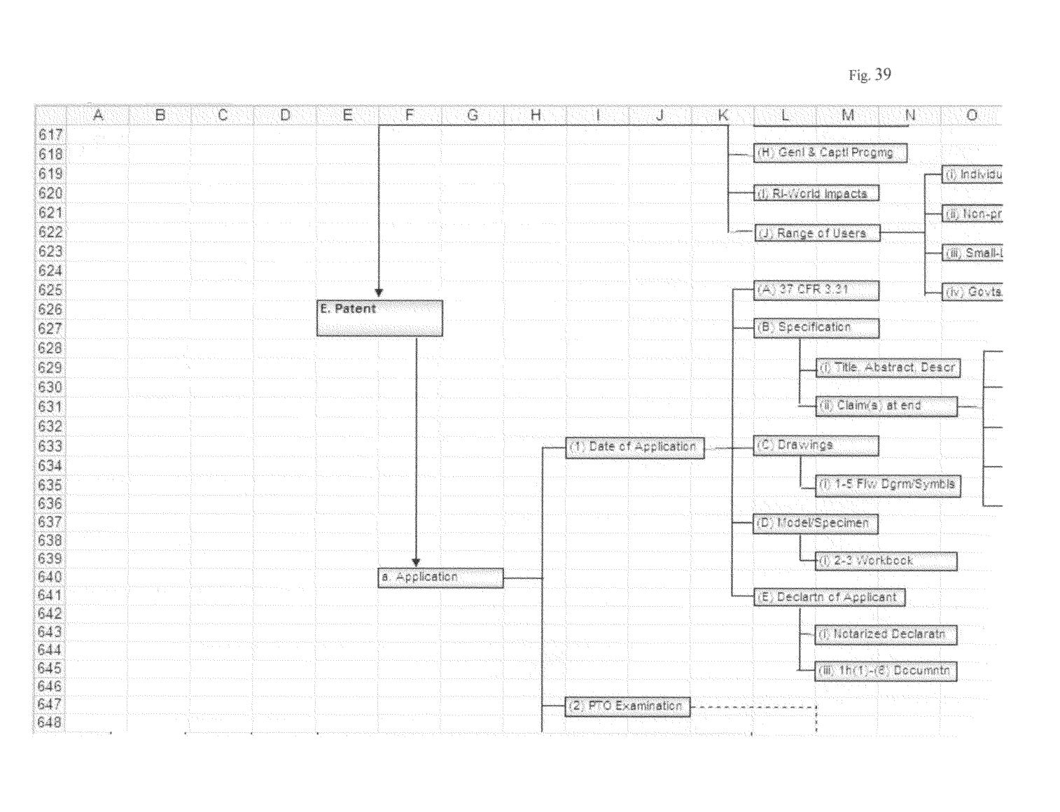

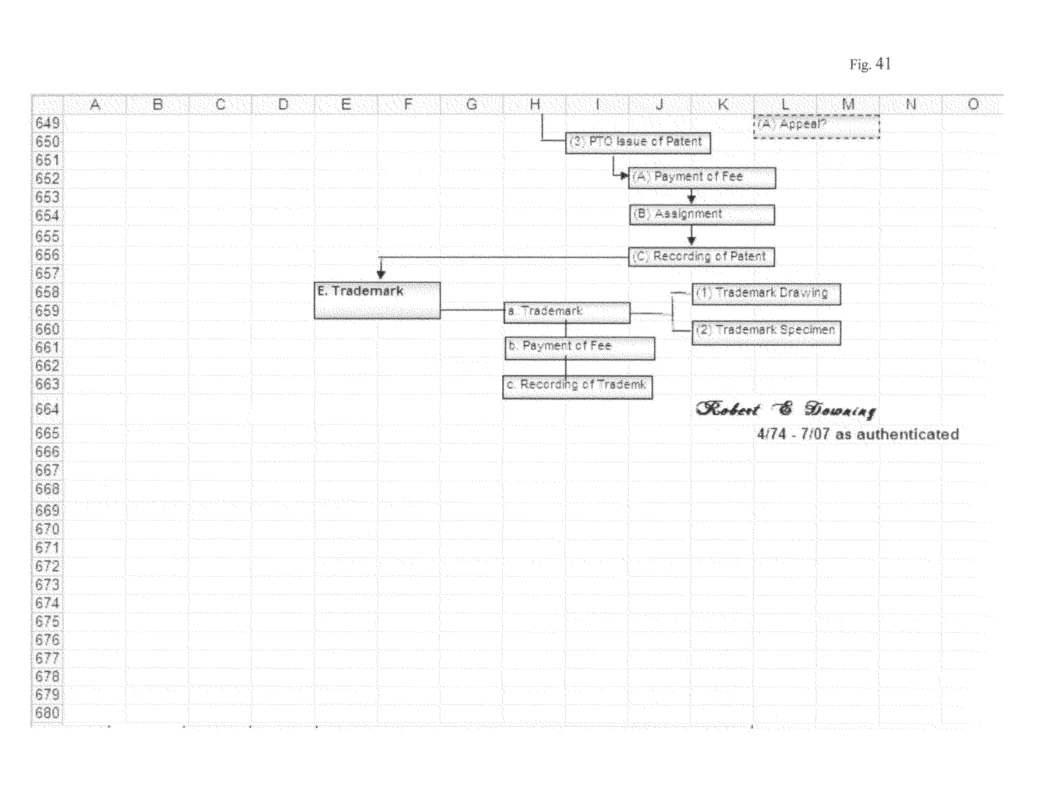

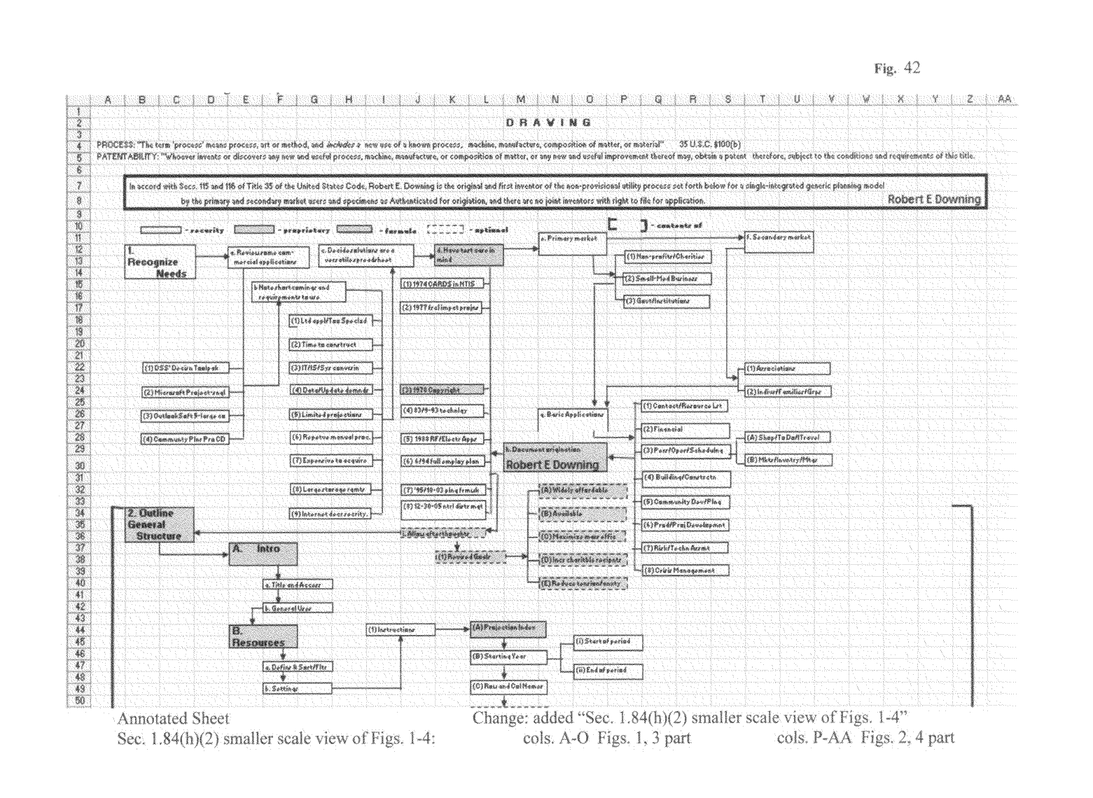

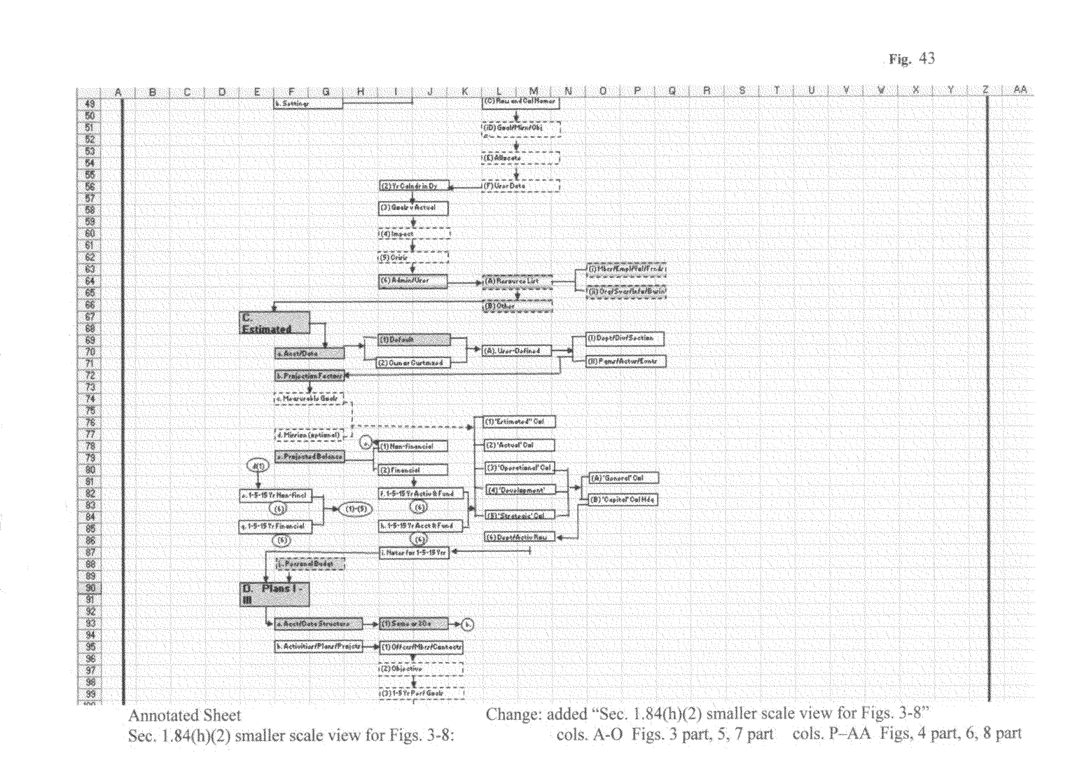

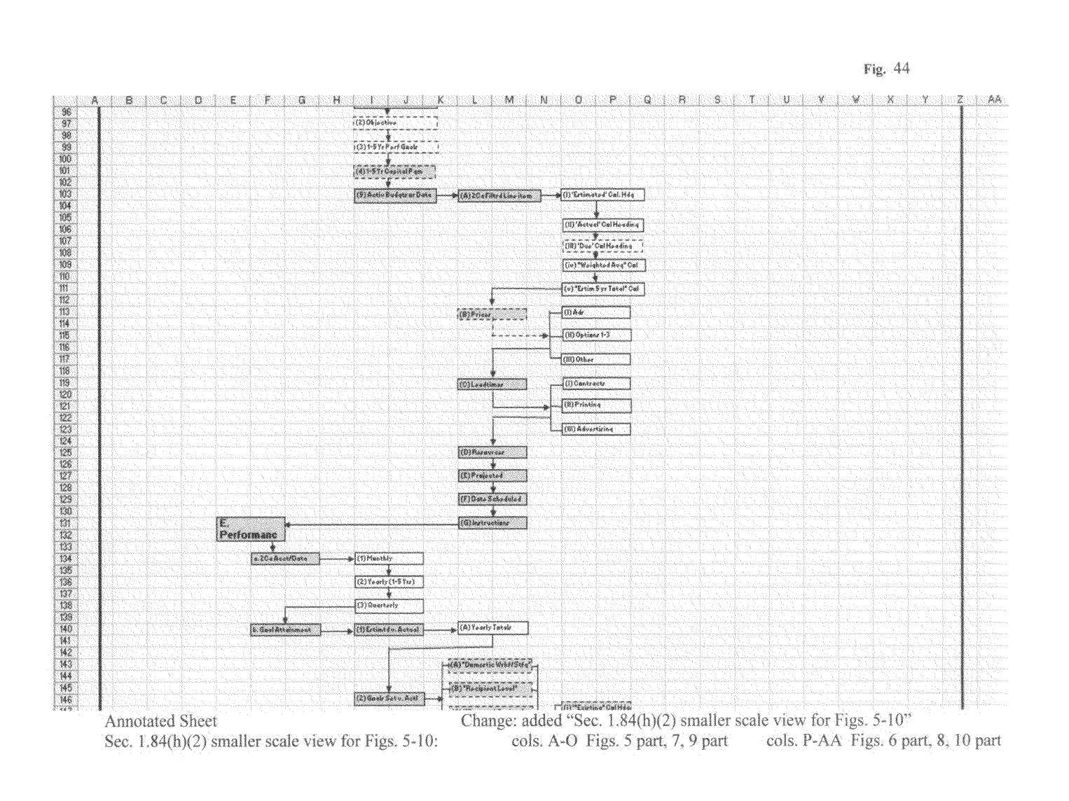

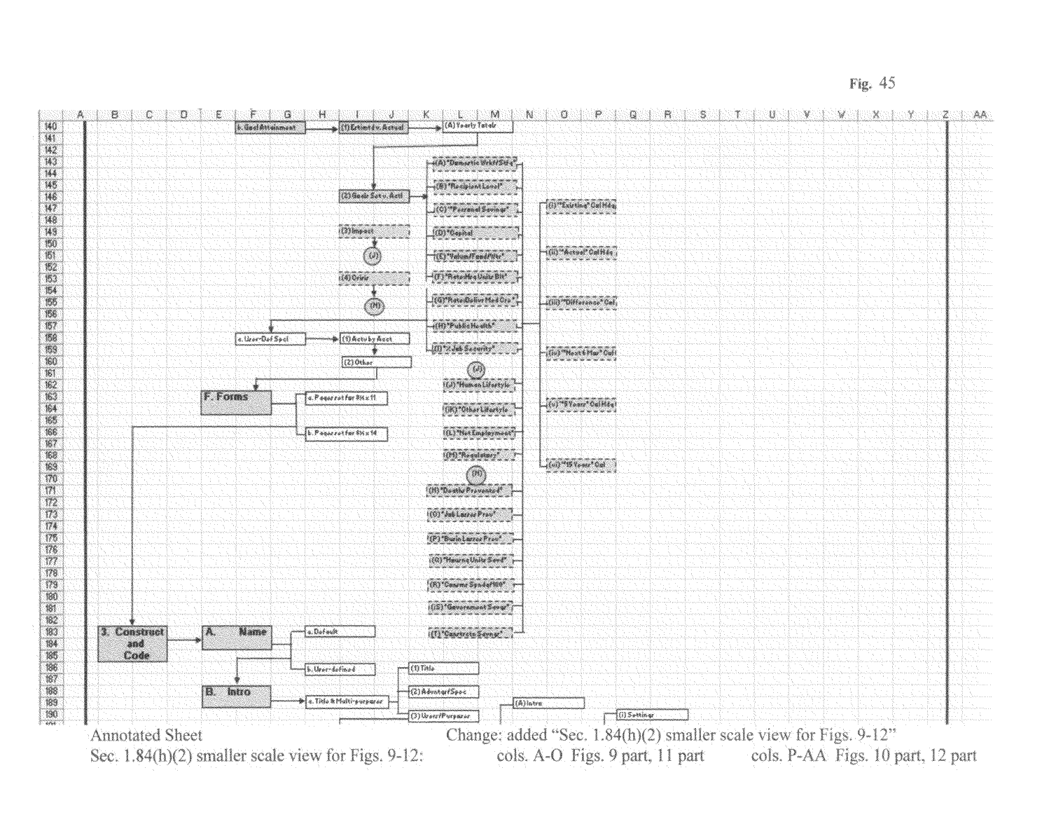

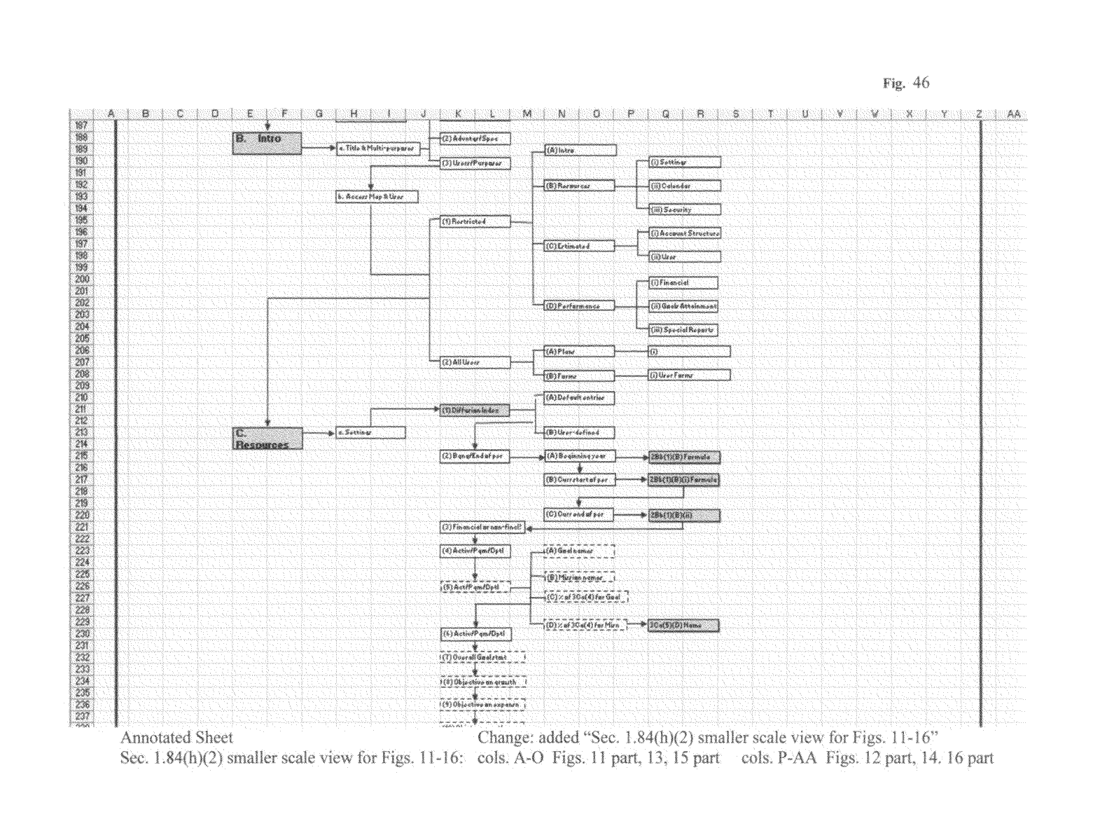

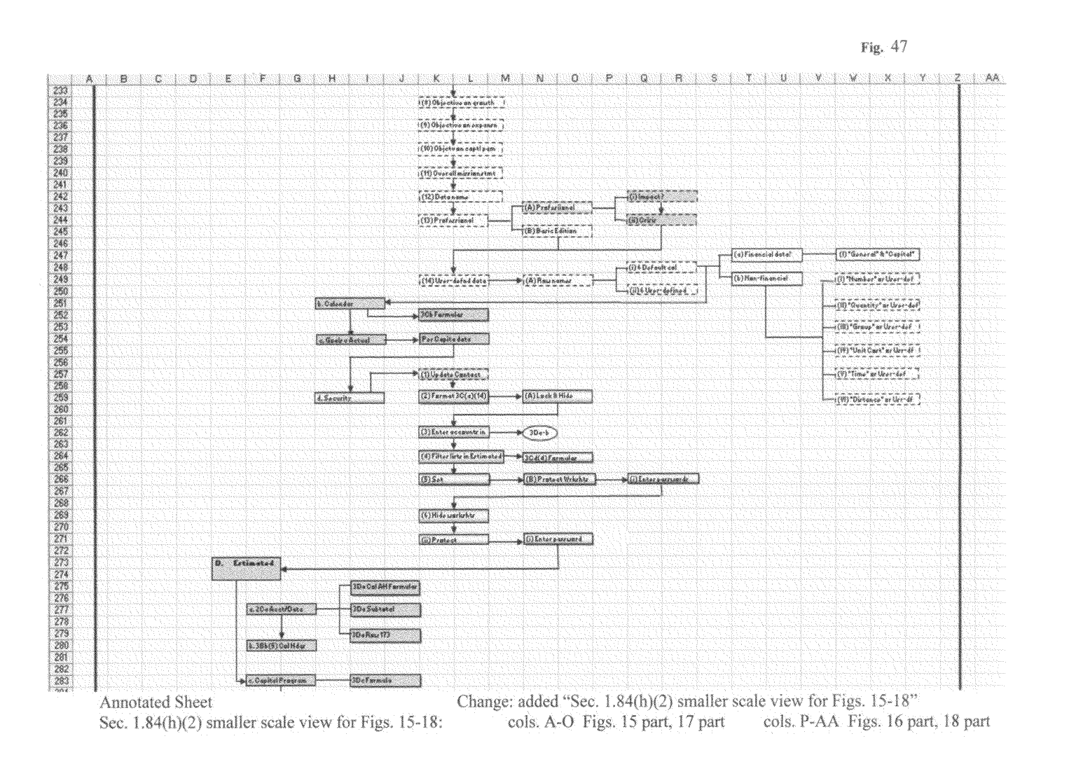

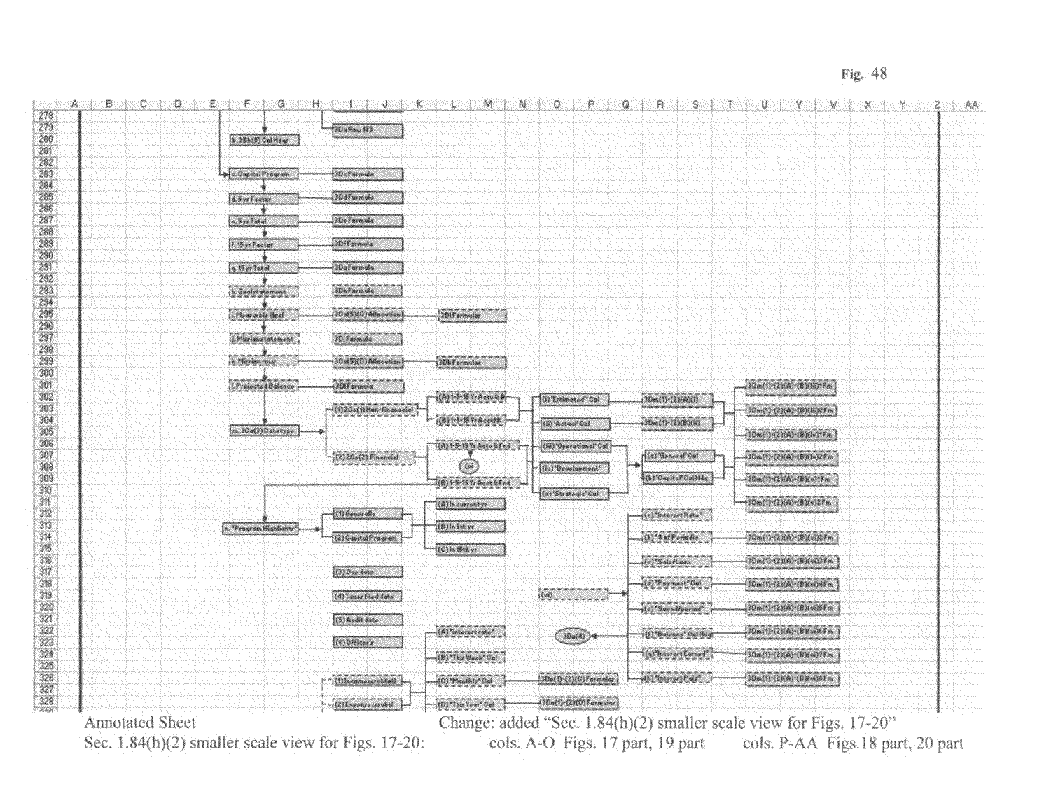

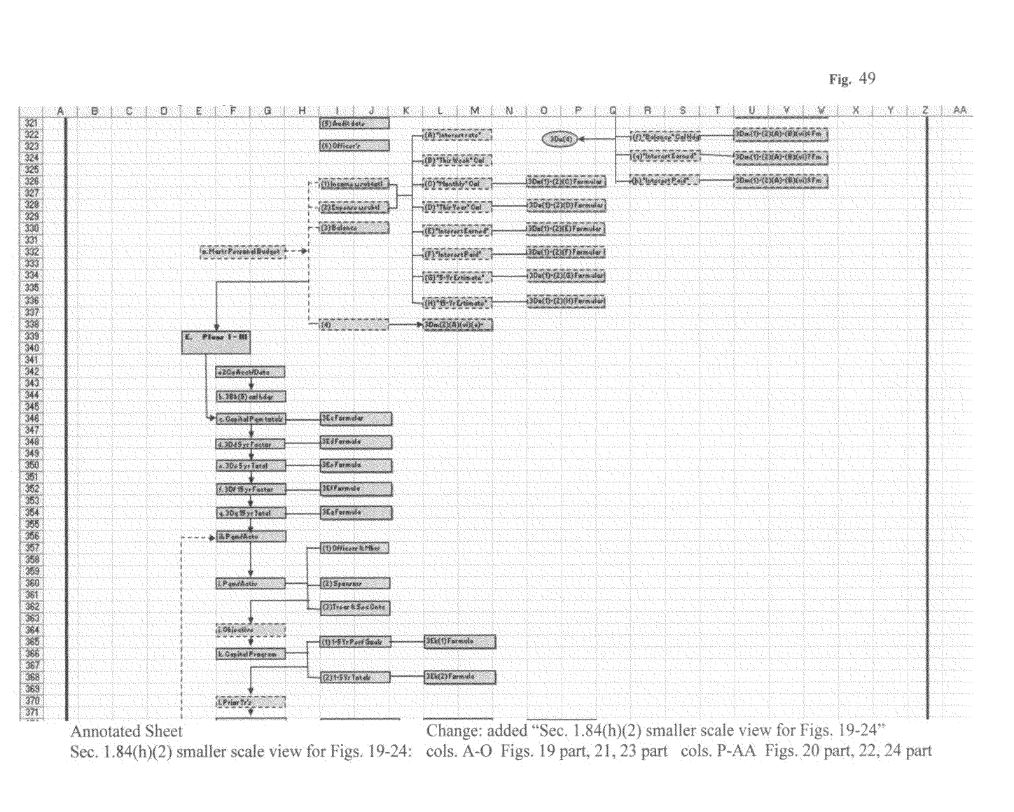

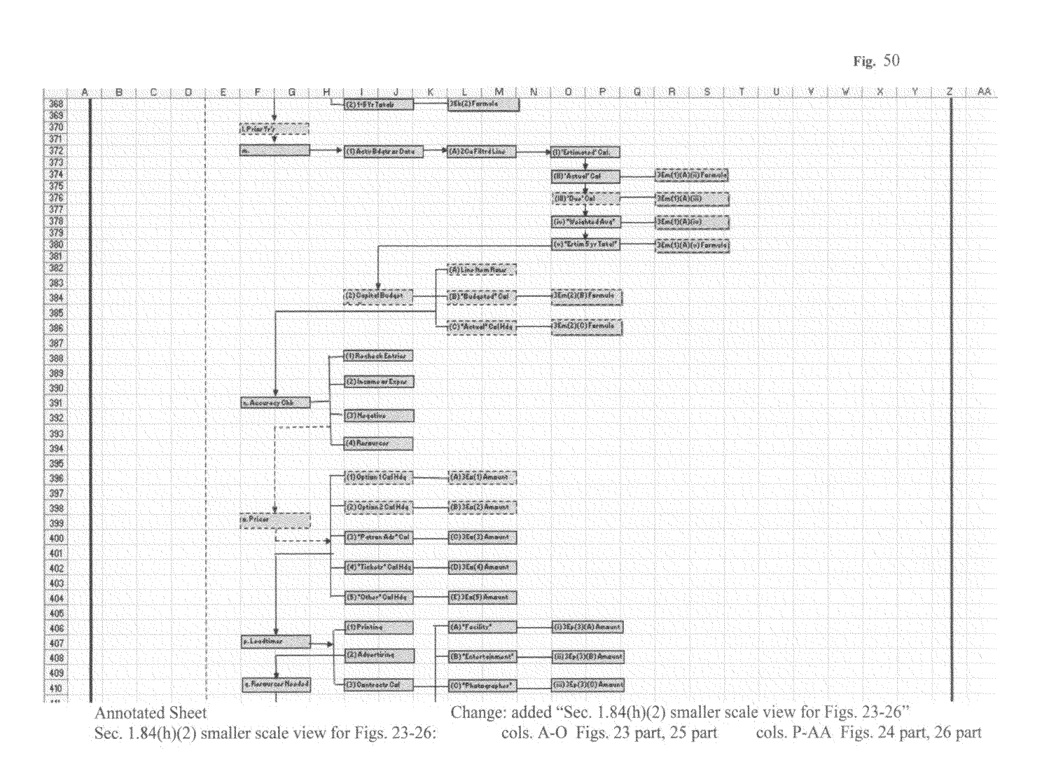

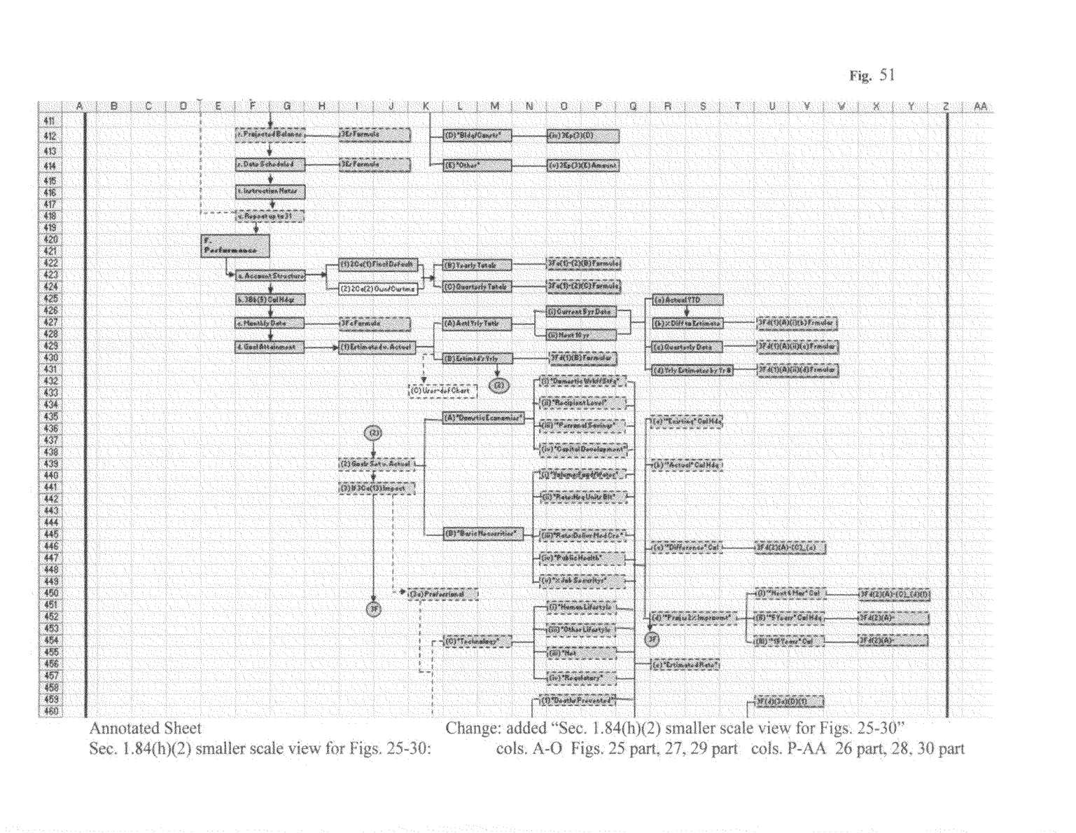

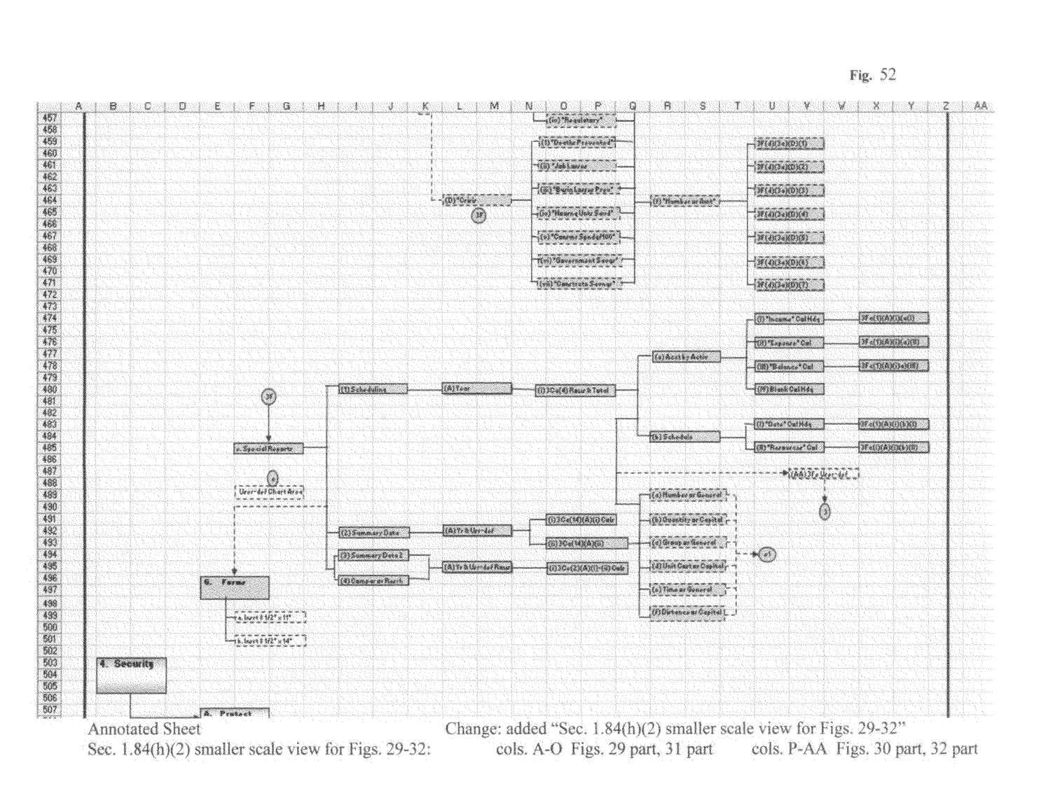

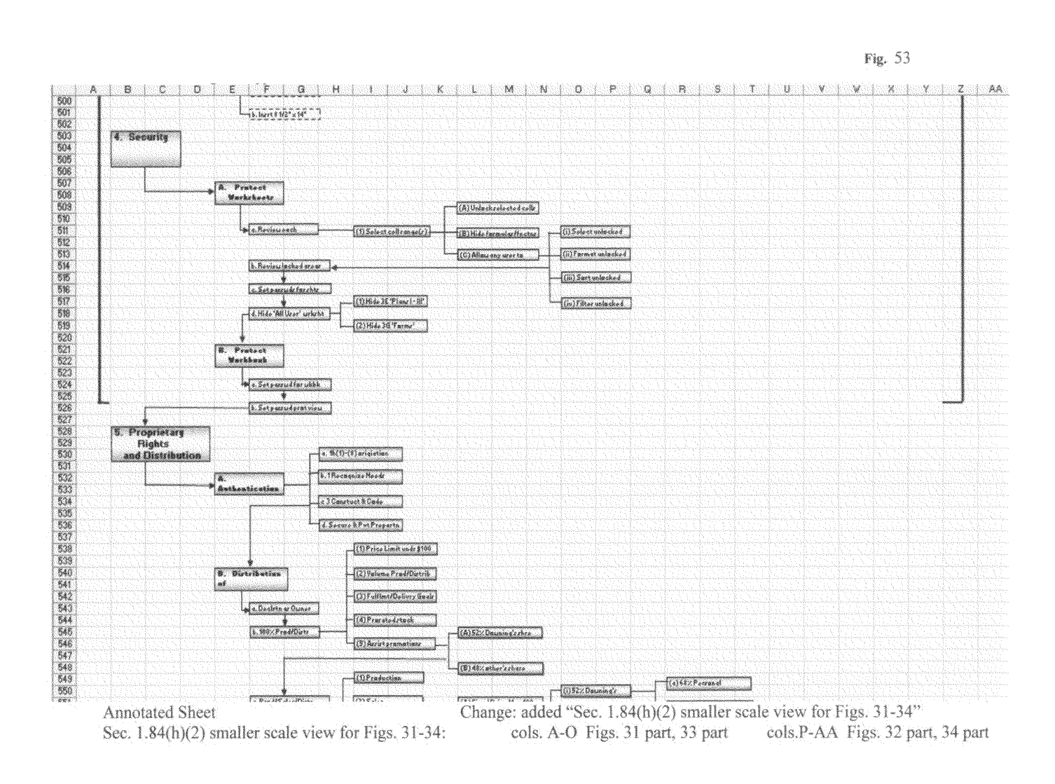

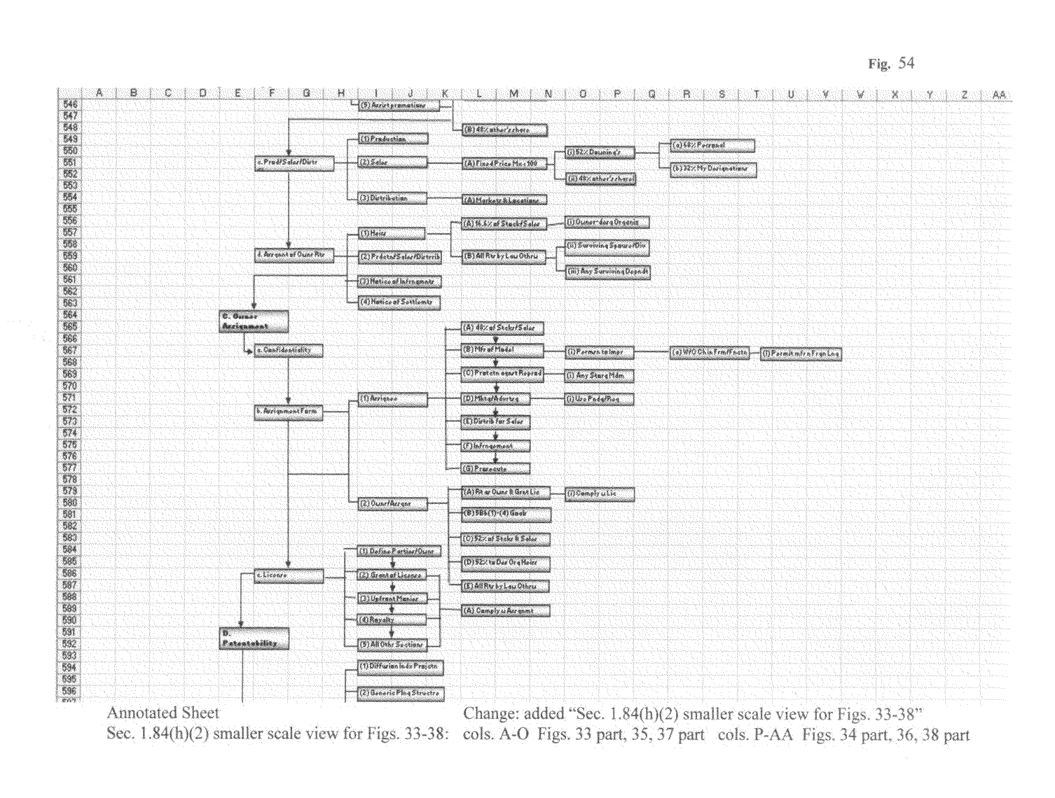

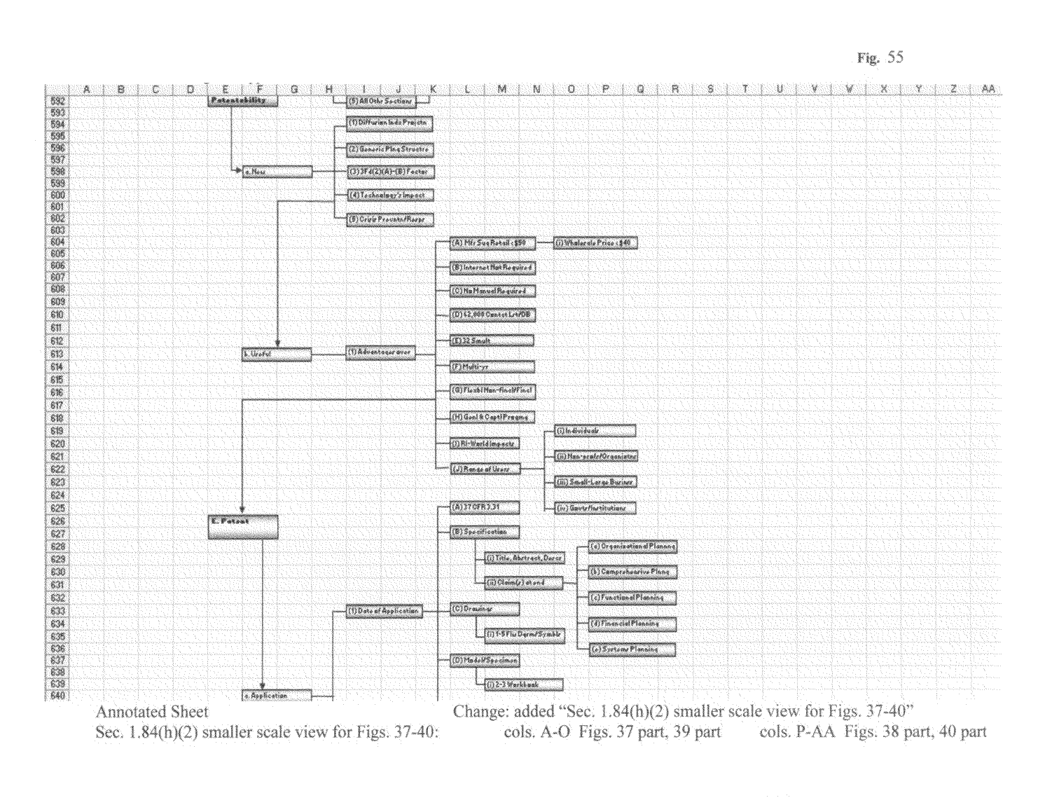

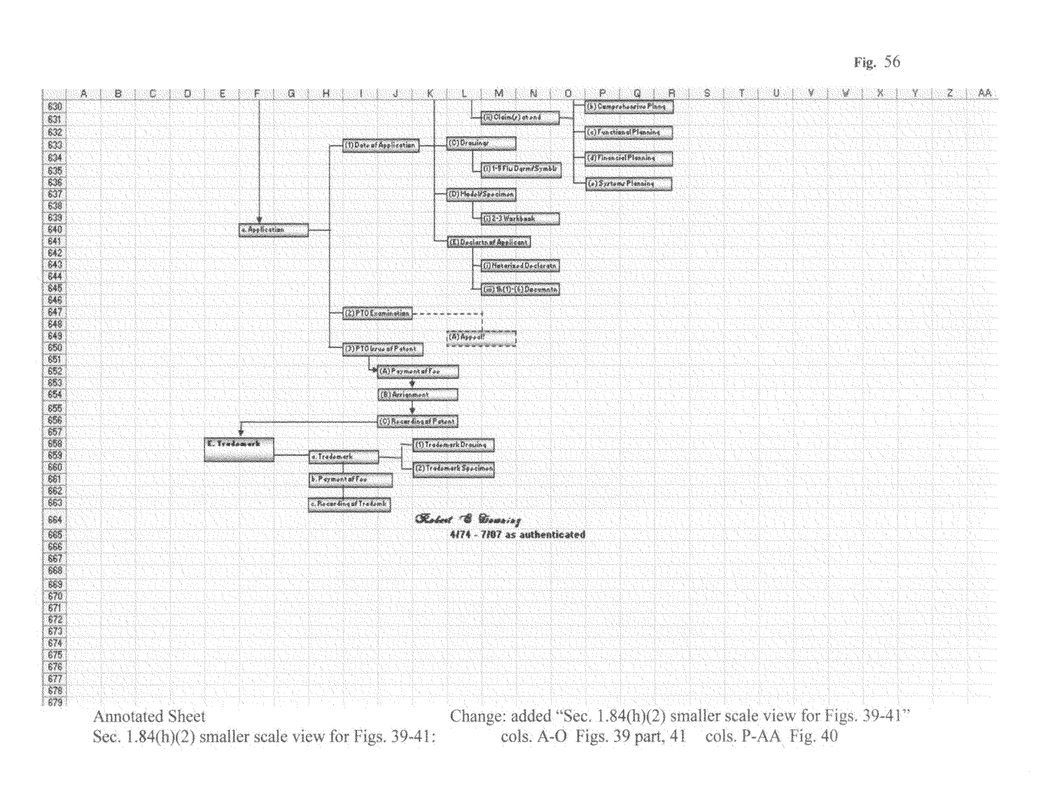

The drawing depicts structure, format, proprietary information, and process. As prefaced with reference to general authority and declaration as owner is outlined in five parts: 1.Recognize Needs (cells B11-V40, FIGS. 1-4), 2. Outline General Structure (cells B34-S183, FIGS. 3-12), 3. Construct and Code (cells B183-Y502, FIGS. 11-32), 4. Security (cells B503-P527, FIGS. 31-34), and 5. Proprietary Rights and Distribution (cells B528-V665, FIGS. 33-41). Distribution of Rights (cells E540-V592, FIGS. 33-38) especially includes owner's assignment of rights of any intended heir inclusive of surviving spouse, divorcee dependents, or owner-specified organization (cells F556-Q563, FIGS. 35-36) as well as assignment of other rights (cells E564-V592, FIGS. 35-38). Patentability (cells E591-Q625, FIGS. 37-40) includes processes. Authentication is cells K664-O665, FIG. 41.

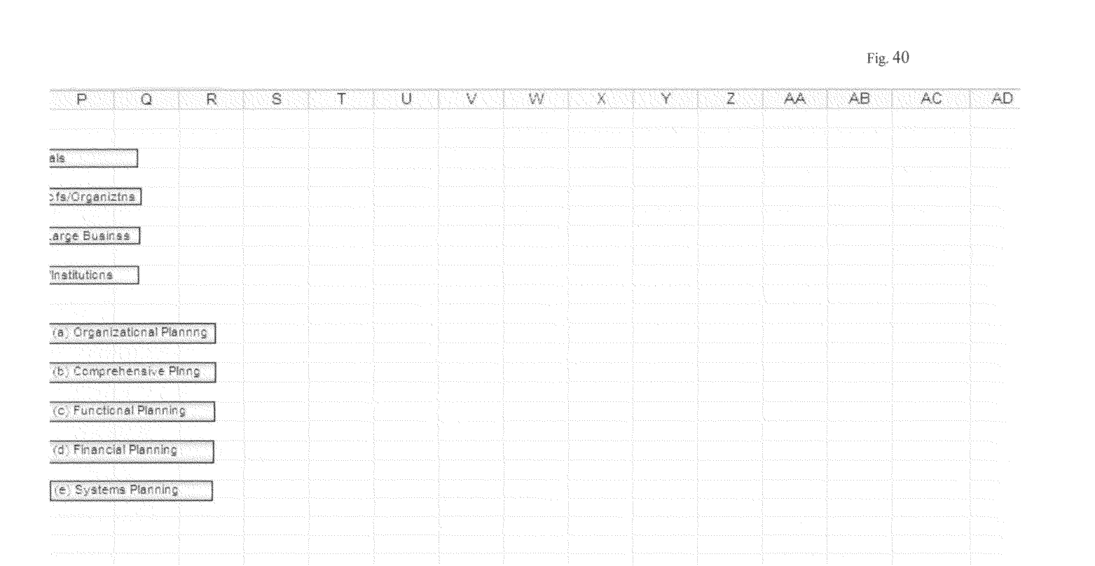

The model as a computer sequence and exhibit conforms to the drawing showing the novelty and utility of the process by its form, structure, pre-definitions, and integral operation. It is a spreadsheet workbook constructed and coded on 8 sheets in two versions on a CD-ROM suitable to microcircuitry, any subsequent storage medium, or module. Utility is enhanced by a site map and instructions provided in the settings for up to 44 templates for planning periods of 1-5-15 years and types of planning specified in the drawing as cells P628-R636, FIG. 40. The diffusion-based projection process, generic planning structure, master personal budget, and simplification of process denoting risks and impacts for domestic economies, basic necessities, technology impacts, crisis prevention/response, and factors/inputs are new and unique reinforcing novelty. The diffusion-based projection process uses a multisystem change factor throughout preset structure allowing recalculations at any point in time.

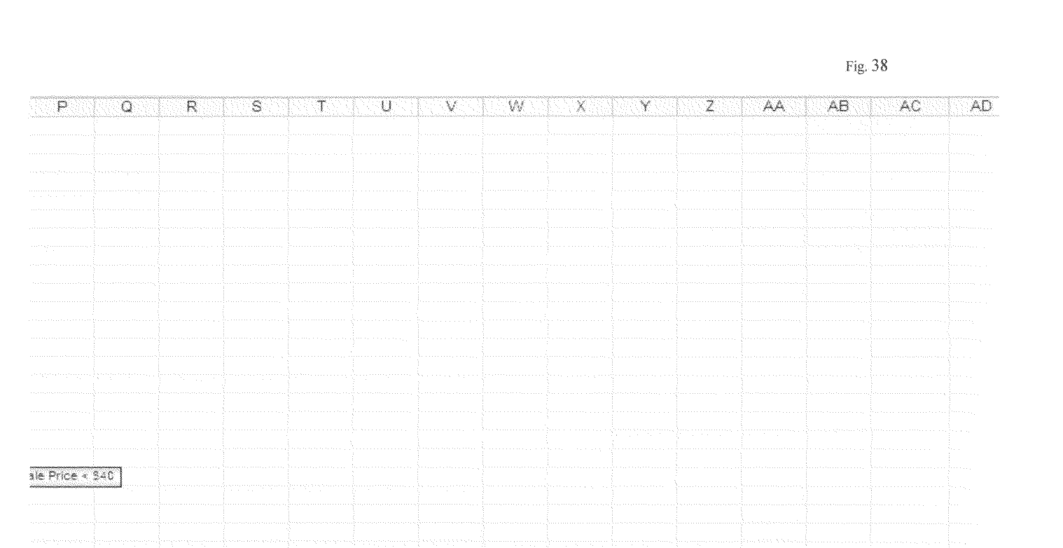

New and useful processes or improvements are defined on the drawing as 5D(1)-(2) Patentability (cells E591-Q625, FIGS. 37-40) in reference to the model conforming to the goals specified on the drawing in cells K38-L38 (FIGS. 3) and N32-P40 (FIGS. 1-4). Novelty is evidenced by dates of authentication, and 5 items specified on the drawing as cells I594-K602 (FIGS. 37-38), corresponding to improved instruction format, structure, and application factors in the model. Useful process is evidenced on the drawing by the advantages over existing products and issued patents or published applications in class schedules 707 and 715 (cells L604-Q625, FIGS. 37-40) relevant to the model's layout, structure, and applications.

Authentication of Origination is intended as part of the Declaration and titled “Appendix to Declaration” comprising 20 pages marked as pages 2-21. Relevant bibliographical data is intended as part of the Declaration.

The manner and process of making the invention is clarified by authenticity and sequence of derivations. The manner of authenticity was further protected by a preconsultation with a patent attorney on Apr. 25, 2008 between 2-3 PM EST approx. where identification of myself, Robert E. Downing, as owner and sole inventor was confirmed and no document was signed by myself at that time. Consistent with the Authentication of Origination, the following are relevant to derivation: model's form and function prior to technology improvements came from 1974 CARDS (a system the owner designed for use with a computer) filed in NTIS; 1976-77 methods of estimation and components for projection as project director on a multiyear fiscal impact model; factors of owner's 1978 copyright registration number TX-112-504; 1983/1993 diffusion index and systemic factors of preventive measures on exceeding technology limits sent to US Treasury Secr.; 1987 comparative chart of potential risks in RF technology and its applications sent to Congressional subcommittee; 1994 full employment plan's generic structure over multi-year planning periods without using simulation model(s); 1995/2003 planning framework of 501(c)(3) organization as test case for abstract and non-financial elements; 2005/2006 national disaster relief legislative mockup-data-calculation's textual outline simplifying impacts and risks in crisis management.

In making the invention, the processes of rights and distributions within cells O550-T552 (FIGS. 33-36) and personal resources from assignments within cells F579-N590 (FIGS. 35-38), had to be considered to fully realize all advantages. Inventor/owner designations are perpetuated in this process even if the inventor/owner is deceased or incapacitated. As inventor/owner and intended from same's personal resources, owner designations consistent with goals are declared here as Amnesty International, Habitat for Humanity, Direct Relief, and Southern Poverty Law Center. Charitable purposes, markets optimizing effectiveness, and quality standard of living without excess are structured and enabled in the process. Interdependency of this process and model therefore preserves effectiveness and helps manage resources through social and technological change.

1. An improvement to an existing process or method wherein the improvement comprises using electronic spreadsheet technology for operationalizing a single-source (Workbook) integrated generic planning model as a predefined unit and suitable to microcircuitry, any storage medium practical, and module as a personal management information system.

2. In furtherance of claim 1 as a unit, a new process and improvement wherein improvement is comprised and reinforced by the diffusion index projections in all elements, generic planning structure, domestic economies and basic necessities factors, technology impact, and crisis prevention and response.

3. In furtherance of claim 1 as a unit, a useful process and improvement wherein improvement is comprised and reinforced by fixed inexpensive acquisition under $100; standard non-reliance on Internet reduces security needs; non-requirement of a hard copy manual; over 62,000 resource list or database; preset generic structure for up to 32 simultaneous activities, plans, projects, or programs; simplified multi-year projection processes and results; flexibility of non-financial applications; general and capital programming; real world impacts; and diversification of users.

4. In furtherance of claim 1 as a unit, a model of templates including risks and impacts for organizational, comprehensive, functional, financial, and systems planning (crisis prevention, technology impacts, R/D).

5. In furtherance of claim 1 as a unit, a model self-adjusting over one-five-fifteen year planning periods in compliance with patentability.

6. In furtherance of defining claim 3 specifically, a model especially relevant to individuals, non-profit organizations, small businesses, government, and institutions in accord with documented authentication of origination referenced in the Description as “Appendix to Declaration” where user can personalize a predefined master budget, generate non-financial or financial reports, organize resources, assess performance, and store forms summarily helping the user to plan, manage, and make decisions more efficiently considering changing societal and technological conditions.
